(19) United States
(12) Patent Application Publication
(10) Pub. No.: US 2023/0196096 A1
(43) Pub. Date: Jun. 22, 2023

(54) Deep Learning Platforms for Automated Visual Inspection

(71) Applicant: AMGEN INC., Thousand Oaks, CA (US)

(72) Inventors: Graham F. Milne, Ventura, CA (US); Thomas C. Pearson, Newbury Park, CA (US); Kenneth E. Hampshire, Thousand Oaks, CA (US); Joseph Peter Bernacki, Thousand Oaks, CA (US); Mark Quinlan, Moorpark, CA (US); Jordan Ray Fine, Ventura, CA (US)

(21) Appl. No.: 17/923,347

(22) PCT Filed: Apr. 30, 2021
(86) PCT No.: PCT/US21/30071

§ 371 Date: Nov. 4, 2022

Related U.S. Application Data
(60) Provisional application No. 63/120,505, filed on Dec. 2, 2020.
(60) Provisional application No. 63/020,232, filed on May 5, 2020.

(51) Int. Cl. G06N 3/08; G06F 9/50

(52) U.S. Cl. CPC G06N 3/08; G06F 9/5027

(57) ABSTRACT

Techniques that facilitate the development and/or modification of an automated visual inspection (AVI) system that implements deep learning are described herein. Some aspects facilitate the generation of a large and diverse training image library, such as by digitally modifying images of real-world containers, and/or generating synthetic container images using a deep generative model. Other aspects decrease the use of processing resources for training, and/or making inferences with, neural networks in an AVI system, such as by automatically reducing the pixel sizes of training images (e.g., by down-sampling and/or selectively cropping container images). Still other aspects facilitate the testing or qualification of an AVI neural network by automatically analyzing a heatmap or bounding box generated by the neural network. Various other techniques are also described herein.

### FIELD OF DISCLOSURE

The present application relates generally to automated visual inspection, and more specifically to techniques for training, testing and utilizing deep learning models to detect defects (e.g., container defects and/or foreign particles) in pharmaceutical or other applications.

### BACKGROUND

In certain contexts, such as quality control procedures for manufactured drug products, it is necessary to examine samples (e.g., containers such as syringes or vials, and/or their contents such as fluid or lyophilized drug products) for defects, with any sample exhibiting defects being rejected, discarded, and/or further analyzed. To handle the quantities typically associated with commercial production of pharmaceuticals, the defect inspection task has increasingly become automated (automated visual inspection, or AVI). Some manufacturers have developed specialized equipment that can detect a broad range of defects, including container integrity defects such as cracks, cosmetic container defects such as scratches or stains on the container surface, and defects associated with the drug product itself such as atypical liquid colors or the presence of foreign particles. However, specialized equipment of this sort occupies a large footprint within a production facility, and is very complex and expensive. As just one example, the Bosch® 5023 commercial line equipment, which is used for the fill-finish inspection stage of drug-filled syringes, includes 15 separate visual inspection stations with a total of 23 cameras (i.e., one or two cameras per station). The high number of camera stations is dictated not only by the range of perspectives required for good coverage of the full range of defects, but also by processing limitations. In particular, the temporal window for computation can be relatively short at high production speeds. This can limit the complexity of individual image processing algorithms for a given station, which in turn necessitates multiple stations that each run image processing algorithms designed to look for only a specific class of defect. In addition to being large and expensive, such equipment generally requires substantial investments in manpower and other resources to qualify and commission each new product line. Maintenance of these AVI systems, and transitioning to a new product line, generally requires highly trained and experienced engineers, and often incurs substantial additional costs when assistance is required from field engineers associated with the AVI system vendor.

### SUMMARY

Embodiments described herein relate to systems and methods that implement deep learning to reduce the size/footprint, complexity, cost, and/or required maintenance for AVI equipment, to improve defect detection accuracy of AVI equipment, and/or to simplify the task of adapting AVI equipment for use with a new product line. One potential advantage of deep learning is that it can be trained to simultaneously differentiate “good” products from products that exhibit any of a number of different defects. This parallelization, combined with the potential for deep learning algorithms to be less sensitive to nuances of perspective and illumination, can also allow a substantial reduction in the number of camera stations. This in turn allows a substantial reduction in the required amount of mechanical conveyance/handling (e.g., via starwheels, carousels, etc.), thereby further reducing the size of the AVI system and removing or reducing a potential source of variability and/or malfunctions. As one example, commercial AVI equipment with a footprint on the order of 3×5 meters may be reduced to a footprint on the order of 1×1.5 meters or less. Deep learning may also reduce the burden of transitioning to a new product line. For example, previously trained neural networks and the associated image libraries may be leveraged to reduce the training burden for the new product line.

While there have been recent, generalized proposals for using deep learning in the visual inspection task, the implementation of deep learning in this context gives rise to a number of significant technical issues, any of which can prevent the advantages listed above from being realized in practice. For example, while it may be relatively straightforward to determine whether a particular deep learning model provides sufficient detection accuracy in a specific use case (e.g., for a particular drug product), the model may be far less accurate in other use cases (e.g., for a different drug product). For instance, while a so-called “confusion matrix” indicating accurate and inaccurate classifications (including false positives and false negatives) may show that a deep learning model correctly infers most or all defects in a particular set of container images, the model may do so by keying/focusing on attributes that do not inherently or necessarily relate to the presence or absence of these defects. As a more specific example, if the containers depicted in a particular training image set happen to exhibit a correlation between meniscus location and the presence of foreign particles within the container, the deep learning model might infer the presence or absence of such particles based on the meniscus location. If a future product does not exhibit the same correlation between particle presence and meniscus location, however, the model could perform poorly for that new line. To avoid outcomes of that sort, in some embodiments, the AVI system may generate a “heatmap” indicative of which portion(s) of a container image contributed the most to a particular inference for that image (e.g., “defect” or “no defect”). Moreover, the AVI system may automatically evaluate the heatmap to confirm that the deep learning model is keying on the expected/appropriate part of the image when making an inference. In implementations that use object detection rather than classification, the AVI system may instead evaluate performance of the object detection model by comparing the bounding boxes that the model generates for detected objects (e.g., particles) to user-identified object locations. In each of these implementations, insights are gained into the reasoning or functioning of the deep learning model, and may be leveraged to increase the probability that the deep learning model will continue to perform well in the future.

Another technical issue raised by the implementation of deep learning in AVI relates to processing demands, at both the training stage and the production/inference stage. In particular, the training and usage of a neural network can easily exceed the hardware capabilities (e.g., random access memory size) associated with an AVI system. Moreover, hardware limitations may lead to long processing times that are unacceptable in certain scenarios, such as when inspecting products at commercial production quantities/rates. This can be especially problematic when there is a need to detect small defects, such as small particles, that might require a far higher image resolution than other defect types. In some embodiments, to avoid requiring that all training images be at the highest needed resolution, and/or to avoid capturing multiple images of each container at different resolutions, one or more smaller training images (i.e., images with fewer pixels) are derived from each higher-resolution image. Various techniques may be used for this purpose. If one neural network is intended to detect a relatively coarse defect that does not require high resolution (e.g., absence of a needle shield), for example, the training images may be generated by down-sampling the original container images. As another example, if a particular neural network is intended to detect defects in a relatively small/constrained region of the container, the training images for that model may be generated by automatically cropping the original container images to exclude at least some areas outside of the region of interest. Moreover, if a particular type of defect is associated with a varying region of interest (e.g., defects on a plunger that can be anywhere in a range of potential positions along a syringe barrel), the cropping may be preceded by an image processing operation in which the region of interest is automatically identified within the original image (e.g., using deep learning object detection or a more traditional technique such as template matching or blob analysis).

Yet another technical issue raised by the implementation of deep learning in AVI relates to generating an image library for training and/or validating the neural network(s). In particular, it can be prohibitively time-consuming and/or costly to generate and curate a container image library that is large and diverse enough to train a neural network to handle the many different ways in which defects may present themselves (e.g., being at different locations on or in a container, having different sizes, shapes and/or other optical qualities, and so on), and possibly also the different ways in which non-defect features may present themselves (e.g., due to variability in container fill levels, plunger positions, etc.). Moreover, the task generally must be repeated each time that a new and substantially different product line (and/or a substantial change to the inspection hardware or process) requires a new training image library. To address these concerns, various techniques disclosed herein facilitate the generation of a larger and more diverse image library. For example, original container images may be modified by virtually/digitally moving the position of a container feature depicted in the images (e.g., plunger position, meniscus position, etc.) to new positions within the images. As another example, original container images may be modified by generating a mirror image that is flipped about an image axis that corresponds to the longitudinal axis of the container. In still other embodiments, images of real-world containers are used to train deep generative models (e.g., generative adversarial networks (GANs) or variational autoencoders (VAEs)) to create synthetic container images for use in the training image library (e.g., along with the original/real-world container images). The synthetic images may include images depicting virtual containers/contents with defects, and/or images depicting virtual containers/contents with no defects.

Other techniques for improving the training and/or utilization of deep learning models in an AVI system are also discussed herein. By using deep learning, with some or all of the enabling technologies described herein, the number of camera stations for, and/or the mechanical complexity of, a commercial AVI system can be substantially reduced, resulting in a smaller footprint, reduced costs, and simplified long-term maintenance issues. Moreover, the use of deep learning and enabling technologies may improve the versatility of a commercial line by making it easier to adapt to new products and/or process variations. For example, training a system on new products or processes (or variations of existing products or processes) may be done by modifying defect image libraries and/or fine-tuning model parameters, rather than the conventional process of manually reprogramming, characterizing and qualifying traditional image processing algorithms. Further still, the use of deep learning and enabling technologies may improve the accuracy of defect detection, including defect categories that have traditionally been difficult to detect reliably (e.g., by avoiding relatively high false positive rates when innocuous bubbles are present in a container).

### BRIEF DESCRIPTION OF THE DRAWINGS

The skilled artisan will understand that the figures described herein are included for purposes of illustration and do not limit the present disclosure. The drawings are not necessarily to scale, and emphasis is instead placed upon illustrating the principles of the present disclosure. It is to be understood that, in some instances, various aspects of the described implementations may be shown exaggerated or enlarged to facilitate an understanding of the described implementations. In the drawings, like reference characters throughout the various drawings generally refer to functionally similar and/or structurally similar components.

FIG. 1 is a simplified block diagram of an example system that may implement various techniques described herein relating to the training, validation and/or qualification of one or more neural networks for automated visual inspection (AVI).

FIG. 2 depicts an example visual inspection system that may be used in the system of FIG. 1.

FIG. 3 depicts another example visual inspection system that may be used in the system of FIG. 1.

FIGS. 4A and 4B depict a perspective view and a top view, respectively, of another example visual inspection system that may be used in the system of FIG. 1.

FIG. 5 depicts an example container image generated by a line scan camera.

FIGS. 6A through 6C depict various example container types that may be inspected using the system of FIG. 1.

FIGS. 7A through 7C depict various example defects that may be associated with the container types of FIGS. 6A through 6C (or their contents).

FIG. 8 depicts an example automated cropping technique that can be applied to a container image.

FIG. 9A depicts various features, of an example container type, that may exhibit variability between containers or container lots.

FIG. 9B depicts an example automated, dynamic cropping technique that can be applied to a container image.

FIG. 10 depicts the use of an example metric for ensuring diversity of container images in a training image library.

FIG. 11A depicts an example technique for modifying a container image to expand and diversify a training image library.

FIG. 11B depicts various features, of an example container type, that may be varied to expand and diversify a training image library.

FIG. 12 depicts an example technique for generating synthetic container images using a generative adversarial network (GAN).

FIG. 13 depicts an example technique for generating synthetic container images using a variational autoencoder (VAE).

FIGS. 14A and 14B depict an example technique for aligning a container image using an edge detection technique.

FIG. 15 depicts an example technique for excluding the use of misaligned container images when training and/or validation of AVI neural networks.

FIG. 16A depicts a simplistic representation of a heatmap that a neural network may generate for a container image.

FIG. 16B depicts an example of an actual heatmap generated by a neural network for a container image

FIG. 17 depicts example container zones that may each be associated with a different defect category.

FIGS. 18A through 18D depict various example processes for performing automated heatmap analysis.

FIG. 19A depicts example bounding box and confidence score image annotations output by an AVI neural network trained to perform object detection.

FIG. 19B depicts example outputs of an AVI neural network trained to perform segmentation.

FIG. 19C depicts a confusion matrix comparing different defect detection techniques.

FIG. 20 is a flow diagram of an example method for reducing the usage of processing resources when training neural networks to perform AVI for respective defect categories.

FIG. 21 is a flow diagram of an example method for training an AVI neural network to more accurately detect defects by expanding and diversifying the training image library.

FIG. 22 is a flow diagram of another example method for training an AVI neural network to more accurately detect defects by expanding and diversifying the training image library.

FIG. 23 is a flow diagram of an example method for evaluating the reliability of a trained AVI neural network that performs image classification.

FIG. 24 is a flow diagram of an example method for evaluating the reliability of a trained AVI neural network that performs object detection.

### DETAILED DESCRIPTION

The various concepts introduced above and discussed in greater detail below may be implemented in any of numerous ways, and the described concepts are not limited to any particular manner of implementation. Examples of implementations are provided for illustrative purposes.

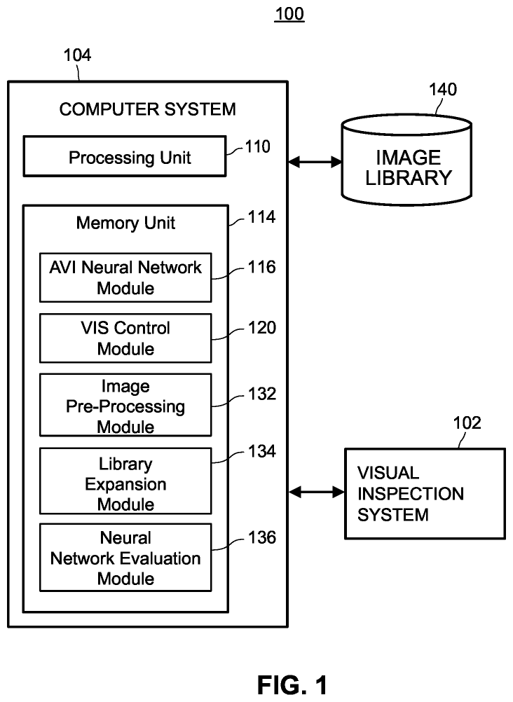

FIG. 1 is a simplified block diagram of an example system 100 that may implement various techniques relating to the training, validation and/or qualification of one or more neural networks for automated visual inspection (AVI) (also referred to herein as “AVI neural network(s)”). Once trained and qualified, the AVI neural network(s) may be used in production to detect defects associated with containers and/or contents of those containers. In a pharmaceutical context, for example, the AVI neural network(s) may be used to detect defects associated with syringes, cartridges, vials or other container types (e.g., cracks, scratches, stains, missing components, etc., of the containers), and/or to detect defects associated with liquid or lyophilized drug products within the containers (e.g., the presence of fibers and/or other foreign particles, variations in color of the product, etc.). As used herein, “defect detection” may refer to the classification of container images as exhibiting or not exhibiting defects (or particular defect categories), and/or may refer to the detection of particular objects or features (e.g., particles or cracks) that are relevant to whether a container and/or its contents should be considered defective, depending on the embodiment.

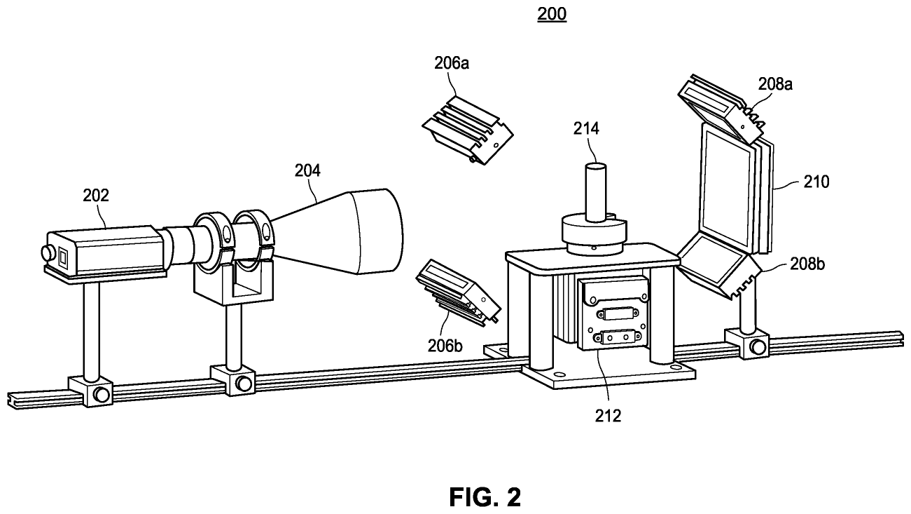

System 100 includes a visual inspection system 102 communicatively coupled to a computer system 104. Visual inspection system 102 includes hardware (e.g., a conveyance mechanism, light source(s), camera(s), etc.), as well as firmware and/or software, that is configured to capture digital images of a sample (e.g., a container holding a fluid or lyophilized substance). Visual inspection system 102 may be any of the visual inspection systems described below with reference to FIGS. 2 through 4, for example, or may be some other suitable system. For ease of explanation, system 100 is described herein as training and validating one or more AVI neural networks using container images from visual inspection system 102. It is understood, however, that this need not be the case. For example, training and/or validation may be performed using container images generated by a number of different visual inspection systems instead of, or in addition to, visual inspection system 102. In some embodiments, some or all of the container images used for training and/or validation are generated using one or more offline (e.g., lab-based) “mimic stations” that closely replicate important aspects of commercial line equipment stations (e.g., optics, lighting, etc.), thereby expanding the training and/or validation library without causing excessive downtime of the commercial line equipment. The development, arrangement and use of example mimic stations are shown and discussed in PCT Patent Application No. PCT/US20/59776 (entitled “Offline Troubleshooting and Development for Automated Visual Inspection Stations” and filed on Nov. 10, 2020), the entirety of which is hereby incorporated herein by reference. Visual inspection system 102 may be such a mimic station, for example.

Visual inspection system 102 may image each of a number of containers sequentially. To this end, visual inspection system 102 may include, or operate in conjunction with, a cartesian robot, carousel, starwheel and/or other conveying means that successively move each container into an appropriate position for imaging, and then move the container away once imaging of the container is complete. While not shown in FIG. 1, visual inspection system 102 may include a communication interface and processors to enable communication with computer system 104.

Computer system 104 may generally be configured to control/automate the operation of visual inspection system 102, and to receive and process images captured/generated by visual inspection system 102, as discussed further below. Computer system 104 may be a general-purpose computer that is specifically programmed to perform the operations discussed herein, or may be a special-purpose computing device. As seen in FIG. 1, computer system 104 includes a processing unit 110, and a memory unit 114. In some embodiments, however, computer system 104 includes two or more computers that are either co-located or remote from each other. In these distributed embodiments, the operations described herein relating to processing unit 110 and memory unit 114 may be divided among multiple processing units and/or memory units, respectively.

Processing unit 110 includes one or more processors, each of which may be a programmable microprocessor that executes software instructions stored in memory unit 114 to execute some or all of the functions of computer system 104 as described herein. Processing unit 110 may include one or more graphics processing units (GPUs) and/or one or more central processing units (CPUs), for example. Alternatively, or in addition, some of the processors in processing unit 110 may be other types of processors (e.g., application-specific integrated circuits (ASICs), field-programmable gate arrays (FPGAs), etc.), and some of the functionality of computer system 104 as described herein may instead be implemented in hardware.

Memory unit 114 may include one or more volatile and/or non-volatile memories. Any suitable memory type or types may be included in memory unit 114, such as read-only memory (ROM), random access memory (RAM), flash memory, a solid-state drive (SSD), a hard disk drive (HDD), and so on. Collectively, memory unit 114 may store one or more software applications, the data received/used by those applications, and the data output/generated by those applications.

Memory unit 114 stores the software instructions of various modules that, when executed by processing unit 110, performs various functions for the purpose of training, validating, and/or qualifying one or more AVI neural networks. Specifically, in the example embodiment of FIG. 1, memory unit 114 includes an AVI neural network module 116, a visual inspection system (VIS) control module 120, an image pre-processing module 132, a library expansion module 134, and a neural network evaluation module 136. In other embodiments, memory unit 114 may omit one or more of modules 120, 132, 134 and 136 and/or include one or more additional modules. In addition, or alternatively, one, some, or all of modules 116, 120, 132, 134 and 136 may be implemented by a different computer system (e.g., a remote server coupled to computer system 104 via one or more wired and/or wireless communication networks). Moreover, the functionality of any one of modules 116, 120, 132, 134 and 136 may be divided among different software applications and/or computer systems. As just one example, in an embodiment where computer system 104 accesses a web service to train and use one or more AVI neural networks, the software instructions of AVI neural network module 116 may be stored at a remote server.

AVI neural network module 116 comprises software that uses images stored in an image library 140 to train one or more AVI neural networks. Image library 140 may be stored in memory unit 114, or in another local or remote memory (e.g., a memory coupled to a remote library server, etc.). In addition to training, module 116 may implement/run the trained AVI neural network(s), e.g., by applying images newly acquired by visual inspection system 102 (or another visual inspection system) to the neural network(s), possibly after certain pre-processing is performed on the images as discussed below. In various embodiments, the AVI neural network(s) trained and/or run by module 116 may classify entire images (e.g., defect vs. no defect, or presence or absence of a particular type of defect, etc.), detect objects in images (e.g., detect the position of foreign objects that are not bubbles within container images), or some combination thereof (e.g., one neural network classifying images, and another performing object detection). As used herein, unless the context clearly indicates a more specific use, “object detection” broadly refers to techniques that identify the particular location of an object (e.g., particle) within an image, and/or that identify the particular location of a feature of a larger object (e.g., a crack or chip on a syringe or cartridge barrel, etc.), and can include, for example, techniques that perform segmentation of the container image or image portion (e.g., pixel-by-pixel classification), or techniques that identify objects and place bounding boxes (or other boundary shapes) around those objects. In some embodiments, memory unit 114 also includes one or more other model types, such as a model for anomaly detection (discussed below).

Module 116 may run the trained AVI neural network(s) for purposes of validation, qualification, and/or inspection during commercial production. In one embodiment, for example, module 116 is used only to train and validate the AVI neural network(s), and the trained neural network(s) is/are then transported to another computer system for qualification and inspection during commercial production (e.g., using another module similar to module 116). In some embodiments where AVI neural network module 116 trains/runs multiple neural networks, module 116 includes separate software for each neural network.

In some embodiments, VIS control module 120 controls/automates operation of visual inspection system 102 such that container images can be generated with little or no human interaction. VIS control module 120 may cause a given camera to capture a container image by sending a command or other electronic signal (e.g., generating a pulse on a control line, etc.) to that camera. Visual inspection system 102 may send the captured container images to computer system 104, which may store the images in memory unit 114 for local processing (e.g., by module 132 or module 134 as discussed below). In alternative embodiments, visual inspection system 102 may be locally controlled, in which case VIS control module 120 may have less functionality than is described herein (e.g., only handling the retrieval of images from visual inspection system 102), or may be omitted entirely from memory unit 114.

Image pre-processing module 132 processes container images generated by visual inspection system 102 (and/or other visual inspection systems) in order to make the images suitable for inclusion in image library 140. As discussed further below, such processing may include extracting certain portions of the container images, and/or generating multiple derivative images for each original container image, for example. Library expansion module 134 processes container images generated by visual inspection system 102 (and/or other visual inspection systems) to generate additional, synthetic container images for image library 140. As the term is used herein, “synthetic” container images refers to container images that depict containers (and possibly also container contents) that are either digitally modified versions of real-world containers, or do not correspond to any real-world container at all (e.g., entirely digital/virtual containers).

In operation, the computer system 104 stores the container images collected by visual inspection system 102 (possibly after processing by image pre-processing module 132), as well as any synthetic container images generated by library expansion module 134, and possibly real-world and/or synthetic container images from one or more other sources, in image library 140. AVI neural network module 116 then uses at least some of the container images in image library 140 to train the AVI neural network(s), and uses other container images in library 140 (or in another library not shown in FIG. 1) to validate the trained AVI neural network(s). As the terms are used herein, “training” or “validating” a neural network encompasses directly running the software that trains or validates/runs the neural network, and also encompasses initiating the training or validation (e.g., by commanding or requesting a remote server to train and/or run the neural network). In some embodiments, for example, computer system 104 may “train” a neural network by accessing a remote server that includes module 116 (e.g., accessing a web service supported by the remote server).

In some embodiments, neural network evaluation module 136 (and/or one or more other modules not shown in FIG. 1) can assist in the training phase, and/or in the testing/qualification of a trained model (e.g., for one or more of the trained AVI neural network(s)). For example, neural network evaluation module 136 may process heatmaps (e.g., occlusion heatmaps or gradient-weighted class activation mapping (grad-CAM) heatmaps) generated by AVI neural network module 116 when an AVI neural network makes an inference (e.g., when inferring the presence or absence of a defect) for a real-world and/or synthetic container image, in order to determine whether that inference was made for the “correct” reason. If a neural network infers the presence of a syringe plunger defect, for example, the neural network evaluation module 136 may analyze the corresponding heatmap to determine whether the neural network focused/keyed on the portion of the container image that depicted the plunger, rather than some other portion of the image. Alternatively, or in addition, neural network evaluation module 136 may process data indicative of a bounding box generated by AVI neural network module 116 when an AVI neural network detects an object (e.g., foreign particle) within a real-world or synthetic container image, in order to determine whether the object was correctly identified. As will be seen from the following description, neural network evaluation module 136 generally evaluates heatmaps if an AVI neural network performs image classification, and instead evaluates other data indicating particular areas within container images (e.g., bounding boxes or pixel-wise labeled areas) if an AVI neural network performs object detection. The operation of each of modules 116 through 136 is discussed in further detail below, with reference to various elements of FIGS. 2 through 24.

FIGS. 2 through 4 depict various example visual inspection systems, any one of which may be used as the visual inspection system 102 of FIG. 1. Referring first to FIG. 2, an example visual inspection system 200 includes a camera 202, a lens 204, forward-angled light sources 206a and 206b, rear-angled light sources 208a and 208b, a backlight source 210, and an agitation mechanism 212. Camera 202 captures one or more images of a container 214 (e.g., a syringe, vial, cartridge, or any other suitable type of container) while container 214 is held by agitation mechanism 212 and illuminated by light sources 206, 208 and/or 210 (e.g., with VIS control module 120 activating different light sources for different images, sequentially or simultaneously). Container 214 may hold a liquid or lyophilized pharmaceutical product, for example.

Camera 202 may be a high-performance industrial camera or smart camera, and lens 204 may be a high-fidelity telecentric lens, for example. In one embodiment, camera 202 includes a charge-coupled device (CCD) sensor. For example, camera 202 may be a Basler® pilot piA2400-17gm monochrome area scan CCD industrial camera, with a resolution of 2448×2050 pixels. As used herein, the term “camera” may refer to any suitable type of imaging device (e.g., a camera that captures the portion of the frequency spectrum visible to the human eye, or an infrared camera, etc.).

The different light sources 206, 208 and 210 may be used to collect images for detecting defects in different categories. For example, forward-angled light sources 206a and 206b may be used to detect reflective particles or other reflective defects, rear-angled light sources 208a and 208b may be used for particles generally, and backlight source 210 may be used to detect opaque particles, and/or to detect incorrect dimensions and/or other defects of containers (e.g., container 214). Light sources 206 and 208 may include CCS® LDL2-74X30RD bar LEDs, and backlight source 210 may be a CCS® TH-83X75RD backlight, for example.

Agitation mechanism 212 may include a chuck or other means for holding and rotating (e.g., spinning) containers such as container 214. For example, agitation mechanism 212 may include an Animatics® SM23165D SmartMotor, with a spring-loaded chuck securely mounting each container (e.g., syringe) to the motor.

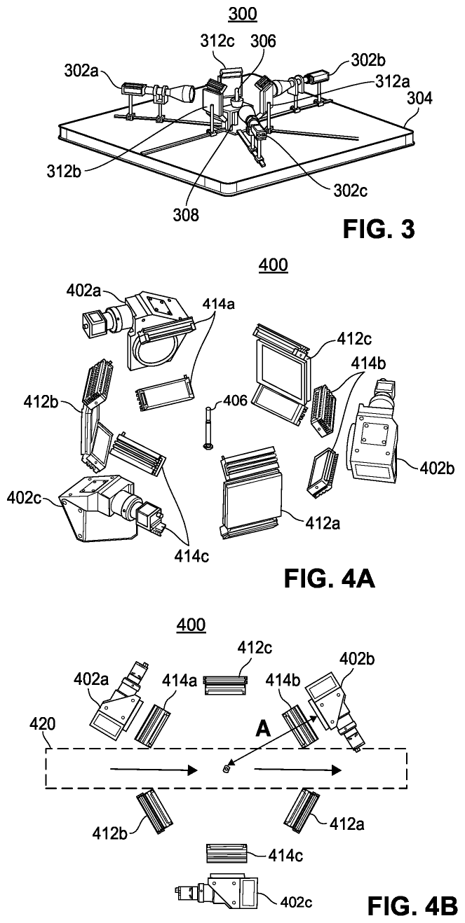

While the visual inspection system 200 may be suitable for producing container images to train and/or validate one or more AVI neural networks, the ability to detect defects across a broad range of categories may require multiple cameras with different perspectives. Moreover, automated handling/conveyance of containers may be desirable in order to obtain a much larger set of container images, and therefore train the AVI neural network(s) to more accurately detect defects. FIGS. 3 and 4 depict other example visual inspection systems that may facilitate such features.

Referring first to FIG. 3, an example visual inspection system 300 includes three cameras 302a through 302c mounted on a platform 304, in a generally radial configuration around (and directed in towards) a container 306 (e.g., a syringe, vial, cartridge, or any other suitable type of container). Each of cameras 302a through 302c may be similar to camera 202 and may include a telecentric lens similar to lens 204, for example, and container 306 may hold a liquid or lyophilized pharmaceutical product. An agitation mechanism 308 holds and agitates container 306. Agitation mechanism 308 may be similar to mechanism 212, for example. Opposite each of cameras 302a through 302c is a respective one of rear light sources 312a through 312c. In the depicted embodiment, each of rear light sources 312a through 312c includes both rear-angled light sources (e.g., each similar to the combination of light sources 208a and 208b) and a backlight source (e.g., similar to backlight source 210). In the depicted embodiment, cameras 302a through 302c are aligned such that the optical axis of each falls within the same horizontal plane, and passes through container 306.

FIGS. 4A and 4B depict a perspective view and a top view, respectively, of yet another example visual inspection system 400 that may be used as visual inspection system 102 of FIG. 1. Visual inspection system 400 includes three cameras 402a through 402c (possibly mounted on a platform similar to platform 304), in a generally radial configuration around (and directed in towards) a container 406 (e.g., a syringe, vial, cartridge, or any other suitable type of container) holding a liquid or lyophilized product. In the depicted embodiment, each of cameras 402a through 402c is coupled to a right-angle telecentric lens, in order to reduce the overall footprint while maintaining telecentric performance. For example, each of cameras 402a through 402c may be a Basler® Ace CMOS camera coupled to an OptoEngineering® TCCR23048-C right-angle telecentric lens. An agitation mechanism (not shown in FIG. 4A or 4B) may hold and agitate container 406. For example, visual inspection system 400 may include an agitation mechanism similar to mechanism 212.

Opposite each of cameras 402a through 402c is a respective one of rear light sources 412a through 412c. In the depicted embodiment, each of rear light sources 412a through 412c includes both rear-angled light sources (e.g., similar to light sources 208a and 208b) and a backlight source (e.g., similar to backlight source 210), and cameras 402a through 402c are aligned such that the optical axis of each falls within the same horizontal plane, and passes through container 406. Unlike visual inspection system 300, visual inspection system 400 also includes forward-angled light sources 414a through 414c (e.g., each similar to the combination of light sources 206a and 206b).

The triangular camera configuration of visual inspection systems 300 and 400 can increase the space available for multiple imaging stations, and potentially provide other advantages. For example, such an arrangement may make it possible to capture the same defect more than once, either at different angles (e.g., for container defects) or with three shots/images simultaneously (e.g., for particle defects), which in turn could increase detection accuracy. As another example, such an arrangement may facilitate conveyance of containers into and out of the imaging region. FIG. 4B shows one possible conveyance path 420 for automated conveyance of each container into and out of the imaging region of visual inspection system 400. For example, a robotic arm may convey each container (e.g., from a bin or tub of containers) along path 420 for imaging. In general, automated conveyance is preferred not only to increase throughput and decrease labor costs, but also to improve cleanliness and clarity of the containers. For example, syringes can be directly pulled from, and reinserted into, syringe tubs with no human handling (e.g., in an enclosure that is cleaner than the surrounding laboratory atmosphere). This can reduce the amount of dust and other debris (e.g., on container surfaces) that can interfere with the detection of small particles or other defects. Automated (e.g., robotic) conveyance can also improve the alignment of containers within a fixture, thereby ensuring better-aligned images. Image alignment is discussed in further detail below. In one embodiment, an IAI® three-axis cartesian robot is used to convey containers (e.g., along path 420).

In alternative embodiments, visual inspection system 300 or visual inspection system 400 may include additional components, fewer components, and/or different components, and/or the components may be configured/arranged differently than shown in FIG. 3 or 4. In one alternative embodiment, for example, visual inspection system 300 or 400 may include one or more additional cameras at one or more angles of inclination/declination, and/or at different positions around the perimeter of the container. As another example, the light sources shown may be configured differently, or other optics (e.g., lenses, mirrors, etc.) may be used, and so on. As still another example, visual inspection system 300 or 400 may include ring light-emitting diode (LED) lights above and/or below the container (e.g., continuous LED ring lights that each have a ring diameter substantially greater than the diameter of the container, and with each ring being positioned in a plane that is orthogonal to the longitudinal axis of the container). However, ring lights may interfere with simple conveyance to and from the imaging region.

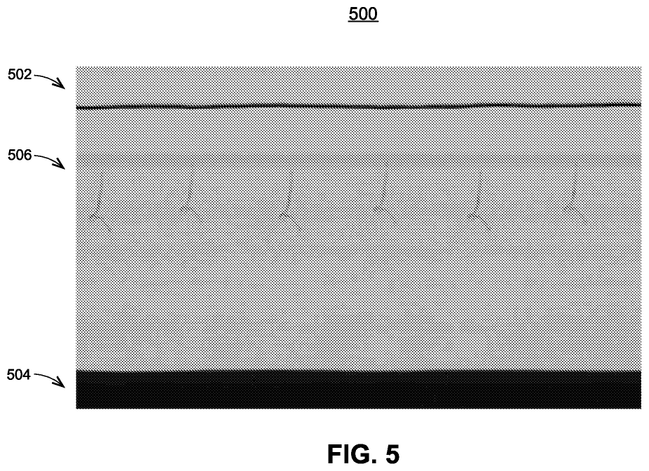

In some embodiments, visual inspection system 102 of FIG. 1 includes a line scan camera, which captures a single, one-dimensional (1D) linear array of pixels. By rotating a container in front of the line scan camera, a series of 1D arrays can be captured and then “stitched” together to form a two-dimensional (2D) rectangular image that is representative of the entire container surface. In effect, the cylindrical container surface is “unwrapped,” which makes the image well suited to inspecting anything on the container wall or surface (e.g., cracks or stains on the container wall, and possibly labels on the container exterior, etc.). FIG. 5 depicts an example container image 500 generated by a line scan camera. In this example, the container is a syringe, and the 2D image generated from the line scans (e.g., by module 132) depicts a fluid meniscus 502, a plunger 504, and a defect 506. Defect 506, which in this example appears multiple times due to multiple rotations of the syringe, may be a crack in the glass that forms the syringe barrel, for example.

Line scan images can have a distinct advantage over more conventional 2D images in that one line scan image can show the entire unwrapped container surface. In contrast, several (e.g., 10 to 20) images are typically needed to inspect the entire surface when 2D images are used. It can consume far less computing resources to analyze one “unwrapped” image as compared to 10 to 20 images. Another advantage of having one “unwrapped” image per container relates to data management. When multiple 2D images are acquired for a defective container, some will show the defect while others will likely not show the defect (assuming the defect is small). Thus, if many (e.g., thousands of) 2D images are captured to generate a training library, those images generally should all be individually inspected to determine whether the images present the defect or not. Those that do not present the defect need to be parsed from the dataset before a deep learning model can be trained. Conversely, linescan images should generally show the defect (if any) somewhere in the image, obviating the need to separately determine whether different images for a single, defective sample should be labeled as defective or non-defective.

Moreover, a line scan image taken over multiple revolutions of the container (e.g., two or more 360 degree rotations) can be used to distinguish objects or defects on the container surface (e.g., dust particles, stains, cracks, etc.) from objects suspended in the container contents (e.g., floating particles, etc.). In particular, if an object or defect is located on the outside or inside wall of the container (or embedded within the container wall), the spacing between the multiple representations of the object/defect within the line scan image (e.g., the horizontal spacing) should be consistent. Conversely, if an object is suspended within the container contents, then the spacing of the multiple representations of the object within the line scan image should vary slightly (e.g., due to motion of liquid contents as the container rotates).

Computer system 104 may store and execute custom, user-facing software that facilitates the capture of training images (for image library 140), for the manual labeling of those images (to support supervised learning) prior to training the AVI neural network(s). For example, in addition to controlling the lights, agitation motor and camera(s) using VIS control module 120, memory unit 114 may store software that, when executed by processing unit 110, generates a graphic user interface (GUI) that enables a user to initiate various functions and/or enter controlling parameters. For example, the GUI may include interactive controls that enable the user to specify the number of frames/images that visual inspection system 102 is to capture, the rotation angle between frames/images (if different perspectives are desired), and so on. The GUI (or another GUI generated by another program) may also display each captured frame/image to the user, and include user interactive controls for manipulating the image (e.g., zoom, pan, etc.) and for manually labeling the image (e.g., “defect observed” or “no defect” for image classification, or drawing boundaries within, or pixel-wise labeling, portions of images for object detection).

In some embodiments, the GUI also enables the user to specify when he or she is unable to determine with certainty that a defect is present (e.g., “unsure”). In pharmaceutical applications, borderline imaging cases are frequently encountered in which the manual labeling of an image is non-trivial. This can happen, for example, when a particle is partially occluded (e.g., by a syringe plunger or cartridge piston), or when a surface defect such as a crack is positioned at the extreme edges of the container as depicted in the image (e.g., for a spinning syringe, cartridge, or vial, either coming into or retreating from view, from the perspective of the camera). In such cases, the user can select the “unsure” option to avoid improperly training any of AVI neural network(s).

It should also be understood that it can be proper to label a container image as “good” (non-defect) even if that image is an image of a “defect” container/sample. In particular, if the defect is out of view (e.g., on the side of an opaque plunger or piston that is hidden from the camera), then the image can properly be labeled as “good.” By pooling “good” images of this sort, the “good” image library can be expanded at no extra cost/burden. This also helps to better align the “good” image library with the material stock used to generate the “defect” containers/samples.

In some embodiments, AVI neural network module 116 performs classification with one or more of the trained AVI neural network(s), and/or generates (for reasons discussed below) heatmaps associated with operation of the trained AVI neural network(s). To this end, module 116 may include deep learning software such as MVTec from HALCON® Vidi® from Cognex®, Rekognition® from Amazon®, TensorFlow, PyTorch, and/or any other suitable off-the-shelf or customized deep learning software. The software of module 116 may be built on top of one or more pre-trained networks, such as ResNet50 or VGGNet, for example, and/or one or more custom networks.

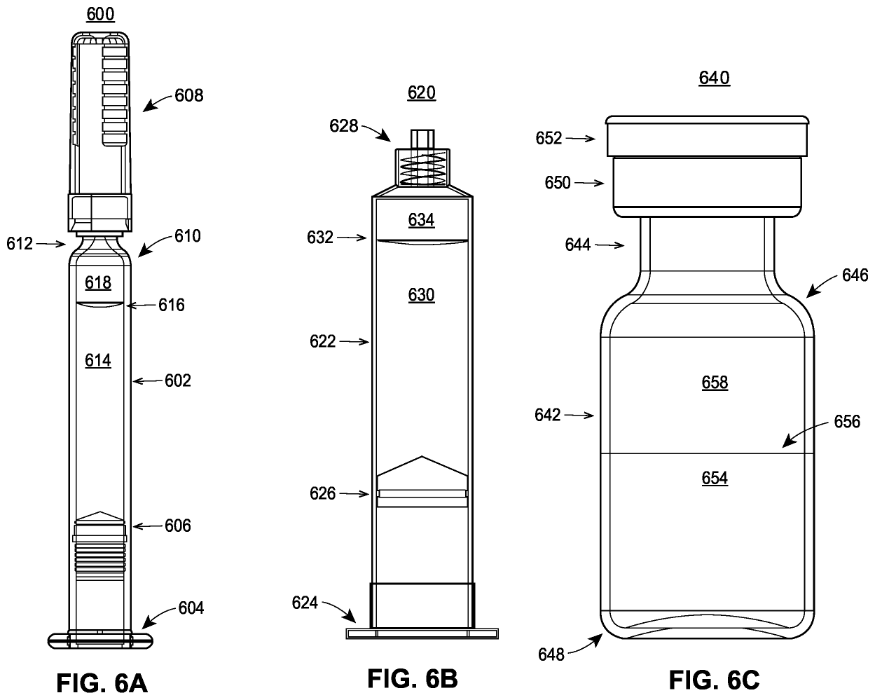

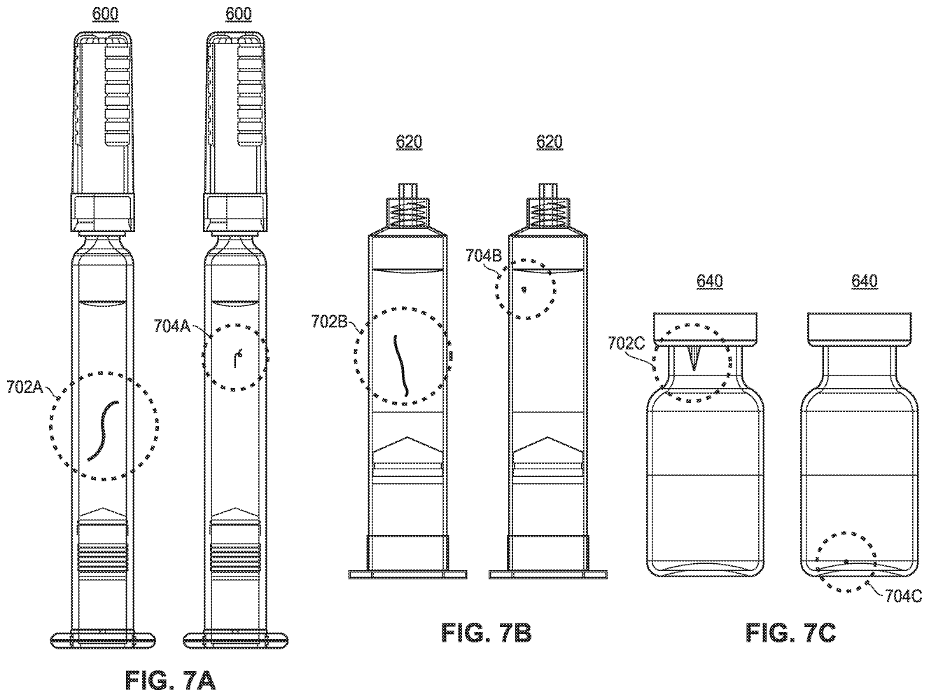

In some of these embodiments, the AVI neural network(s) may include a different neural network to classify container images according to each of a number of different defect categories of interest. The terms “defect category” and “defect class” are used interchangeably herein. FIGS. 6A, 6B, and 6C depict a number of example container types (syringe, cartridge, and vial, respectively), and FIGS. 7A, 7B, and 7C depict possible defects that may be associated with those container types. It should be understood, however, that the systems and methods described herein may also (or instead) be used with other types of containers, and may be also (or instead) be used to detect other types of defects.

Referring first to FIG. 6A, an example syringe 600 includes a hollow barrel 602, a flange 604, a plunger 606 that provides a movable fluid seal within the interior of barrel 602, and a needle shield 608 to cover the syringe needle (not shown in FIG. 6A). Barrel 602 and flange 604 may be formed of glass and/or plastic and plunger 606 may be formed of rubber and/or plastic, for example. The needle shield 608 is separated by a shoulder 610 of syringe 600 by a gap 612. Syringe 600 contains a liquid (e.g., drug product) 614 within barrel 602 and above plunger 606. The top of liquid 614 forms a meniscus 616, above which is an air gap 618.

Referring next to FIG. 6B, an example cartridge 620 includes a hollow barrel 622, a flange 624, a piston 626 that provides a movable fluid seal within the interior of barrel 622, and a luer lock 628. Barrel 622, flange 624, and/or luer lock 628 may be formed of glass and/or plastic and piston 626 may be formed of rubber and/or plastic, for example. Cartridge 620 contains a liquid (e.g., drug product) 630 within barrel 622 and above piston 626. The top of liquid 630 forms a meniscus 632, above which is an air gap 634.

Referring next to FIG. 6C, an example vial 640 includes a hollow body 642 and neck 644, with the transition between the two forming a shoulder 646. At the bottom of vial 640, body 642 transitions to a heel 648. A crimp 650 includes a stopper (not visible in FIG. 6C) that provides a fluid seal at the top of vial 640, and a flip cap 652 covers crimp 650. Body 642, neck 644, shoulder 646, and heel 648 may be formed of glass and/or plastic, crimp 650 may be formed of metal, and flip cap 652 may be formed of plastic, for example. Vial 640 may include a liquid (e.g., drug product) 654 within body 642. The top of liquid 654 may form a meniscus 656 (e.g., a very slightly curved meniscus, if body 642 has a relatively large diameter), above which is an air gap 658. In other embodiments, liquid 654 is instead a solid material within vial 640. For example, vial 640 may include a lyophilized (freeze dried) drug product 654, also referred to as “cake.”

FIGS. 7A, 7B, and 7C show a small sample of possible defects that may be associated with syringe 600, cartridge 620, or vial 640, respectively. As seen in FIG. 7A, for example, syringe 600 may include a crack 702A on barrel 602, or a fiber 704A floating in liquid 614. As seen in FIG. 7B, cartridge 620 may include a crack 702B on barrel 622 or a small particle 704B floating in liquid 630. As seen in FIG. 7C, vial 640 may include a chip 702C or a small particle 704C resting on the bottom of the interior of vial 640.

More generally, the deep learning techniques described herein (e.g., neural networks for image classification and/or object detection) may be used to detect virtually any type of defects associated with the containers themselves, with the contents (e.g., liquid or lyophilized drug products) of the containers, and/or with the interaction between the containers and their contents (e.g., leaks, etc.). As non-limiting examples, the deep learning techniques may be used to detect syringe defects such as: a crack, chip, scratch, and/or scuff in the barrel, shoulder, neck, or flange; a broken or malformed flange; an air line in glass of the barrel, shoulder, or neck wall; a discontinuity in glass of the barrel, shoulder, or neck; a stain on the inside or outside (or within) the barrel, shoulder, or neck wall; adhered glass on the barrel, shoulder, or neck; a knot in the barrel, shoulder, or neck wall; a foreign particle embedded within glass of the barrel, shoulder, or neck wall; a foreign, misaligned, missing, or extra plunger; a stain on the plunger, malformed ribs of the plunger; an incomplete or detached coating on the plunger; a plunger in a disallowed position; a missing, bent, malformed, or damaged needle shield; a needle protruding from the needle shield; etc. Examples of defects associated with the interaction between syringes and the syringe contents may include a leak of liquid through the plunger, liquid in the ribs of the plunger, a leak of liquid from the needle shield, and so on.

Non-limiting examples of defects associated with cartridges may include: a crack, chip, scratch, and/or scuff in the barrel or flange; a broken or malformed flange; an airline in glass of the barrel; a discontinuity in glass of the barrel; a stain on the inside or outside (or within) the barrel; adhered glass on the barrel; a knot in the barrel wall; a foreign, misaligned, missing, or extra piston; a stain on the piston; malformed ribs of the piston; a piston in a disallowed position; a flow mark in the barrel wall; a void in plastic of the flange, barrel, or luer lock; an incomplete mold of the cartridge; a missing, cut, misaligned, loose, or damaged cap on the luer lock; etc. Examples of defects associated with the interaction between cartridges and the cartridge contents may include a leak of liquid through the piston, liquid in the ribs of the piston, and so on.

Non-limiting examples of defects associated with vials may include: a crack, chip, scratch, and/or scuff in the body; an air line in glass of the body; a discontinuity in glass of the body; a stain on the inside or outside (or within) the body; adhered glass on the body; a knot in the body wall; a flow mark in the body wall; a missing, misaligned, loose, protruding or damaged crimp; a missing, misaligned, loose, or damaged flip cap; etc. Examples of defects associated with the interaction between vial and the vial contents may include a leak of liquid through the crimp or the cap, and so on.

Non-limiting examples of defects associated with container contents (e.g., contents of syringes, cartridges, vials, or other container types) may include: a foreign particle suspended within liquid contents; a foreign particle resting on the plunger dome, piston dome, or vial floor; a discolored liquid or cake; a cracked, dispersed, or otherwise atypically distributed/formed cake; a turbid liquid; a high or low fill level; etc. “Foreign” particles may be, for example, fibers, bits of rubber, metal, stone, or plastic, hair, and so on. In some embodiments, bubbles are considered to be innocuous and are not considered to be defects.

In embodiments where different AVI neural networks perform image classification to detect defects in different categories (e.g., by classifying defects in a given category as “present” or “absent”), each defect category may be defined as narrowly or broadly as needed in order to correspond to a particular one of the AVI neural networks. If one of the AVI neural networks is trained to detect only fibers (as opposed to other types of particles) within the liquid contents of a container, for example, then the corresponding defect category may be the narrow category of “fibers.” Conversely, if the AVI neural network is trained to also detect other types of foreign particles in the liquid contents, the defect category may be more broadly defined (e.g., “particles”). As yet another example, if the AVI neural network is trained to detect even more types of defects that can be seen in a certain portion of the container (e.g., cracks or stains in the barrel wall of a syringe or cartridge, or in the body of a vial), the defect category may be still more broadly defined (e.g., “barrel defects” or “body defects”).

While it can be advantageous during development to identify the performance of defect classes individually, AVI during production is primarily concerned with the task of correctly distinguishing “good” containers from “bad” containers, regardless of the specific defect type. Thus, in some alternative embodiments, the AVI neural network module 116 may train and/or run only a single neural network that performs image classification for all defect categories of interest. Use of a single/universal neural network can offer some advantages. One potential advantage is algorithmic efficiency. In particular, a neural network that can consider multiple types of defects simultaneously is inherently faster (and/or requires less parallel processing resources) than multiple networks that each consider only a subset of those defects. Although inference times of about 50 milliseconds (ms) are possible, and can result in acceptable throughput for a single inference stage, sequential processing can result in unacceptably long inspection times. For example, if each of 20 defect classes requires 50 ms for inference, the total inference time (1 second) may cause an unacceptable bottleneck during production.

Another potential advantage is more subtle. As a general rule for good model performance, training image sets should be balanced such that the subsets of images corresponding to each label (e.g., “good” or “defect”) are approximately equal in size. If, for example, a training image library includes 4000 “good” container images (i.e., not exhibiting any defects), then it would be preferable to also have something on the order of 4000 container images exhibiting defects. However, “good” container images are typically much easier to source than images exhibiting defects, because the former do not need to be specially fabricated. Thus, it could be very cumbersome if, say, 4000 images were needed for each and every defect category (e.g., ˜4000 defect images for each of 20 defect categories, or ˜80,000 defect images in total). The task would be far less cumbersome if the “defect” images for all defect categories could be pooled together to train just a single neural network (e.g., ˜200 images for each of 20 defect categories to arrive at ˜4000 total defect images). Pooling defect images of different categories in order to balance out numerous good images can result in a robust image library that encapsulates a much broader range of variability and fine detail. Moreover, pooling defects can substantially increase the variability in the “defect” image library, because the different containers from which the defect images were sourced will be from a broader range of sources. As just one example, defective syringe barrels may be from different lots, which might increase variability in the syringe barrel diameter and therefore increase/improve the diversity of the training image library (e.g., image library 140).

Depending on the type(s) of defects being detected, deep learning models (e.g., the AVI neural network(s) supported by module 116) may rely on a certain level of detail (i.e., a certain resolution) in each container image being inspected. Where high image resolution is needed, current memory and processing capabilities may be insufficient to support inferences at a high throughput level (e.g., during production). In particular, for desktop computing (or, equivalently, embedded industrial computers) an important constraint can be the onboard RAM tied to a processor (e.g., a GPU). The training process for a neural network can consume an enormous amount of memory. For example, a 2400×550 pixel image can easily consume over 12 GB of GPU RAM during training. Moreover, higher resolution images generally increase both the time to train the neural network, and the resulting inference times when the trained network is deployed (e.g., in production).

For images containing macroscopic objects, reducing the resolution of a container image (e.g., by resampling the image to a lower resolution, or using a low-resolution camera in the first instance) may not substantially impact classification performance. However, in pharmaceutical applications, some defect classes relate to objects that are very small compared to the overall container image (e.g., fibers and/or other suspended particles, or stains and/or particles embedded in container glassware, etc.). These defect classes may have dimensions on the order of a few hundred microns long (and for fibers, a substantially shorter width), and be suspended in a much larger container (e.g., in a syringe barrel on the order of 50 mm long). For some of these small defect classes, reducing the resolution through resampling can potentially weaken the depiction of the defect feature and, in extreme cases, remove the defect from the image altogether. Conversely, for macroscopic defect classes (e.g., a missing needle shield) a low-resolution image may be sufficient.

If the defect class with the highest resolution requirement is used to dictate the resolution of all training images in image library 140 (and all images used to perform classification with the trained AVI neural network(s)), the processing/memory constraints noted above can result in unacceptably slow performance. Thus, in some embodiments, system 100 instead implements a phased approach that is at least partially based on the relative dimensions/sizes of the various defect classes (e.g., different defect classes associated with different AVI neural networks). In this phased approach, training images for some defect classes (i.e., the images used to train AVI neural network(s) corresponding to those defect classes) are reduced in size by lowering the resolution of the original container image (down-sampling), while training images for other defect classes are reduced in size by cropping to a smaller portion of the original container image. In some embodiments, training images for some defect classes are reduced in size by both cropping and down-sampling the original container image.

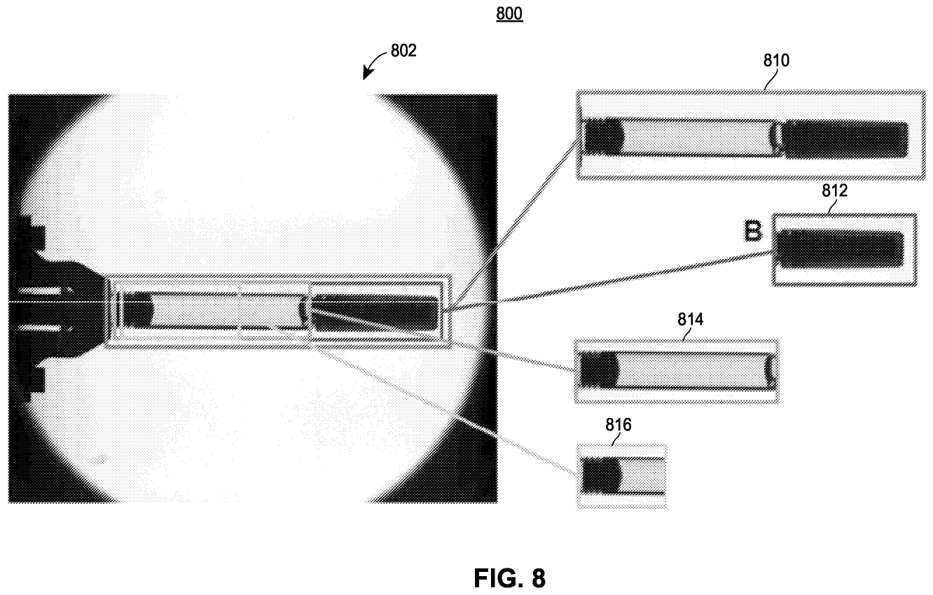

To illustrate an example of this phased approach, as applied to a syringe, FIG. 8 depicts an automated cropping technique 800 that can be applied to a container image 802. In FIG. 8, an image portion 810 represents an overall area of interest within container image 802, with the areas outside of image portion 810 being irrelevant to the detection of any defect categories. As seen in FIG. 8, image portion 810 may be somewhat larger than the container (here, a syringe) in order to capture the region of interest even when the container is slightly misaligned. Image pre-processing module 132 may initially crop all container images from visual inspection system 102 down to the image portion 810.

Regardless of whether module 132 “pre-crops” image 802 down to image portion 810, module 132 reduces image sizes by cropping image 802 (or 810) down to various smaller image portions 812, 814, 816 that are associated with specific defect classes. These include an image portion 812 for detecting a missing needle shield, an image portion 814 for detecting syringe barrel defects, and an image portion 816 for detecting plunger defects. In some embodiments, defect classes may overlap to some extent. For instance, both image portion 812 and image portion 814 may also be associated with foreign particles within the container. In some embodiments, because a missing needle shield is an easily observed (coarse) defect, image pre-processing module 132 also down-samples the cropped image portion 812 (or, alternatively, down-samples image 802 or 810 before cropping to generate image portion 812).

Computer system 104 may then store the cropped and/or down-sampled portions 812 through 816 (and possibly also portion 810) in image library 140 for training of the AVI neural networks. For example, AVI neural network module 116 may use image portion 812 as part of a training image set for a first one of the AVI neural networks that is to be used for detecting missing needle shields, use image portion 814 as part of a training image set for a second one of the AVI neural networks that is to be used for detecting barrel defects and/or particles within the barrel, and use image portion 816 as part of a training image set for a third one of the AVI neural networks that is to be used for detecting plunger defects and/or particles near the plunger dome. Depending on the embodiment, image portions 812, 814, 816 may be the entire inputs (training images) for the respective ones of the AVI neural networks, or the image pre-processing module 132 may pad the image portions 812, 814, 816 (e.g., with constant value pixels) to a larger size.

In some embodiments, image pre-processing module 132 down-samples certain images or image portions not only for the purpose of reducing the usage of memory/processing resources, but also (or instead) to enhance defect detection accuracy. In particular, down-sampling may enhance the ability to classify an image according to certain defect categories, or detect certain objects (e.g., particles or bubbles) or features (e.g., cracks or stains), by eliminating or reducing small-scale artifacts (e.g., artifacts caused by the relative configuration of the illumination system) and/or noise (e.g., quantization noise, camera noise, etc.), so long as the objects or features at issue are sufficiently large, and/or have a sufficiently high contrast with surrounding areas within the container images.

Using the above cropping (and possibly also down-sampling) techniques, a high resolution is preserved for those defect classes that may require it (e.g., low-contrast stains or particles that can be only a few pixels in diameter), without unnecessarily burdening processing resources by using high resolution across all defect classes (e.g., missing needle shields). It is understood that a commercial system (e.g., with components similar to system 100) may include a module similar to module 132, to crop and/or down-sample images of containers during production when making classifications with trained AVI neural networks.

In the example of FIG. 8, image pre-processing module 132 crops the original container image 802 (or pre-cropped image 810) to a fixed region of interest for each defect class. This can be problematic, however, for containers having features that can vary in position (e.g., from lot to lot, or even from container to container). For example, image portion 816 may need to depict a substantial length of the syringe barrel in order to ensure that the plunger is shown, because different syringes may have the plunger depressed to a different location within the barrel. Similarly, a portion of an image of a cartridge may need to depict a substantial length of the cartridge barrel in order to ensure that the piston is shown. As another example, all of image portions 810 through 816 may need to depict a substantial extra width outside of the barrel diameter in order to ensure that the entire width of the syringe is captured (e.g., due to tolerances in barrel diameter, and/or physical misalignment of the syringe).

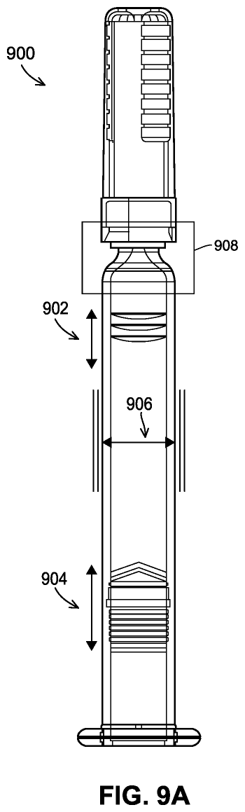

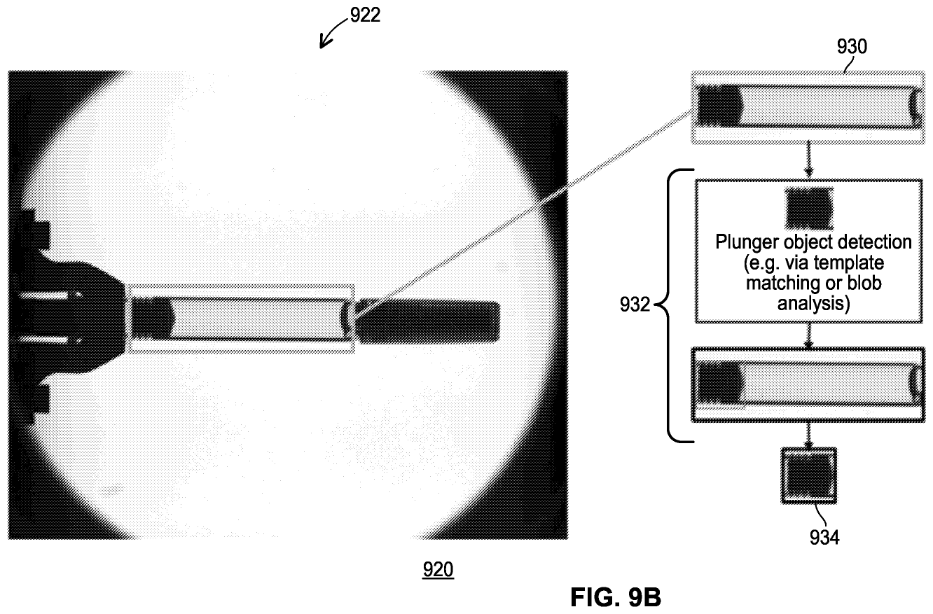

FIG. 9A depicts example features that may vary in position between containers or container lots, for the specific case of a syringe 900. As seen in FIG. 9, features of syringe 900 that may vary in position include a meniscus position 902 (e.g., based on fill levels), a plunger position 904 (e.g., based on how far the plunger has been depressed), a syringe barrel diameter 906 (e.g., due to tolerances and/or differences in lots or products), and a shield-to-shoulder gap 908 (i.e., the spacing between the needle shield and the syringe shoulder, which may be based on factors such as tolerances, differences in lots or products, how tightly the needle shield was put onto the syringe, etc.). Other syringes may also, or instead, vary in other ways (e.g., length, transparency, plunger dome shape, etc.). Similarly, other container types may vary in particular ways. For example, cartridge features that can vary may include features similar to features 902, 904 (for the cartridge piston), 906, and/or 908 (for the gap between a luer lock cap and a shoulder of the cartridge), and vial features that can vary may include features similar to features 902 (for liquid or cake fill level) and/or 906 (for the body width), etc. If image pre-processing module 132 accounts for such variability by including some “buffer” space in the cropped image portions (e.g., portions 810 through 816), some resolution is effectively sacrificed for a given image size, potentially limiting the efficacy of the training process and degrading classification performance.

In some embodiments, to account for feature variability without degrading training efficacy and classification performance, image pre-processing module 132 dynamically localizes regions of interest for defect classes associated with container features having variable positions (e.g., any of features 902 through 908), prior to cropping as discussed above with reference to FIG. 8. FIG. 9B depicts one example of such a technique. In FIG. 9B, image pre-processing module 132 applies an automated, dynamic cropping technique 920 to a container image 922 (e.g., an image captured by visual inspection system 102). As with the technique 800 of FIG. 8, image pre-processing module 132 may initially crop image 922 down to an image portion 930 that excludes areas of container image 922 that are not relevant to any defect class. Module 132 may accomplish this “pre-cropping” based on a fixed region of interest (e.g., with buffer zones to account for tolerances and/or misalignment as discussed above), or by localizing the syringe within image 922 (e.g., using edge detection or other suitable image processing techniques).

Thereafter, at a processing stage 932, module 132 detects the plunger within image portion 930 (i.e., localizes the position of the plunger as depicted in image 930). While module 132 may instead detect the plunger within the original container image 922, this can require more processing time than first pre-cropping image 922 down to image portion 930. Module 132 may use any suitable technique to detect the plunger at stage 932. For example, module 132 may detect the plunger using pattern/object template matching or blob analysis. In some embodiments, module 132 detects the plunger using any suitable object detection technique discussed in U.S. Pat. No. 9,881,367 (entitled “Image Processing Techniques for Plunger Depth Measurement” and issued on Jan. 30, 2018), the entire disclosure of which is hereby incorporated herein by reference.

After image pre-processing module 132 detects the plunger at stage 932, module 132 crops that portion of image 930 (or of image 922) down to an image portion 934. As seen by comparison to image portion 816 of FIG. 8, image portion 934 includes less surrounding area (and possibly no surrounding area) outside of the plunger itself. Thus, resolution of the depicted plunger in image portion 934 is maximized (or nearly maximized). Computer system 104 may then store the cropped portion 934 in image library 140 (e.g., as a training image for one of the AVI neural networks that is to be used for detecting plunger defects and/or particles near the plunger dome). Depending on the embodiment, image portion 934 may be the entire input (training image) for the respective one of the AVI neural networks, or the image pre-processing module 132 may pad the image portion 934 (e.g., with constant value pixels) to a larger size. As with the technique 800, it is understood that a commercial system (e.g., with components similar to system 100) may include a module similar to module 132 to dynamically crop images of containers during production when making classifications with a trained AVI neural network.

While FIG. 9B shows the use of technique 920 to localize a syringe plunger, it is understood that technique 920 (or a similar technique) could instead be applied to any container feature with a variable position (e.g., any of features 902 through 908, or a cartridge piston, a cartridge or vial meniscus or fill level, etc.), or even to container features with substantially fixed positions. Any of the object detection techniques discussed herein (e.g., segmentation) may be used to localize any container feature prior to cropping, for example. For any of the cropping or down-sampling techniques discussed above, care must be taken to ensure that the image transformations do not cause the label of the image (for supervised learning) to become inaccurate. For example, if a particle or other defect depicted in a “defect” image is cropped out, the image may need to be re-labeled as “good.”

Using the technique 800 and/or the technique 920, system 100 can improve deep learning performance by increasing resolution for a given amount of available processing resources and/or a given amount of processing time. Moreover, these techniques may have other advantages, such as reducing the scope of possible image artifacts, noise, or irrelevant features that might confuse the training process. As discussed in further detail below, for example, a neural network for detecting defects in one area (e.g., particles on plungers) might inadvertently be trained to focus/key on other characteristics that are not necessarily relevant to the classification (e.g., the meniscus). Cropping out other areas of the container reduces the likelihood that a neural network will key on the “wrong” portion of a container image when classifying that image.

In some embodiments, system 100 (e.g., module 116) processes each cropped image using anomaly detection. Anomaly detection may be particularly attractive because it can be trained solely on defect-free images, thereby removing the need to create “defect” images and greatly simplifying and expediting generation of the training image library. Alternatively, segmentation may be advantageous, as it can mask other aspects/features of a given image such that those other aspects/features can be ignored. The meniscus, for example, can exhibit large amounts of variation. This can frequently induce false model predictions because the meniscus is a fairly dominant aspect of the image, and because meniscus variation is independent of the defect. Such variations are typically in part due to manufacturing tolerances and in part due to differences in surface tension and viscosity when using different drug products for training. As a result, image classification techniques may have an additional constraint of using only products with the same liquid, thereby further limiting an already limited data set. Conversely, by using object detection (segmentation or otherwise) to ignore the meniscus and other features that vary, deep learning models can incorporate a larger variety of samples into the training image library.

In embodiments where module 116 trains only a single, universal AVI neural network for all defect classes of interest, image resolution may be set so as to enable reliable detection of the finest/smallest defects (e.g., stains or particles that may be only a few pixels wide). Despite the high resolution, this approach may result in the lowest overall inference times due to the single model. Moreover, a single model (neural network) may be preferable because the ultimate desired classification is simply “good” versus “bad (or “non-defect” versus “defect,” etc.). In particular, small false positive and false negative rates are more acceptable for a single model than they are for multiple models that individually have those same rates.

In some embodiments where module 116 trains different AVI neural networks to perform image classification for different defect classes as discussed above, the defect classes may be split into different “resolution bands” with different corresponding AVI neural networks (e.g., three resolution bands for three AVI neural networks). An advantage of this technique is that classification in the lower resolution bands will take less time. The split into the different resolution bands may occur after images have been taken with a single camera (e.g., using down-sampling for certain training or production images) or, alternatively, separate cameras or camera stations may be configured to operate at different resolutions. As noted above, lower resolutions may in some instances enhance detection accuracy (e.g., by reducing artifacts/noise) even where defects are small in size (e.g., small particles). Thus, the appropriate resolution band is not necessarily only a function of defect size, and may also depend on other factors (e.g., typical brightness/contrast).

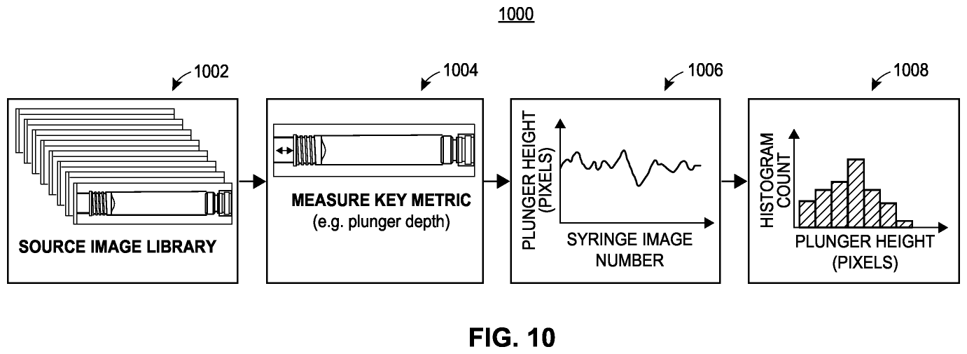

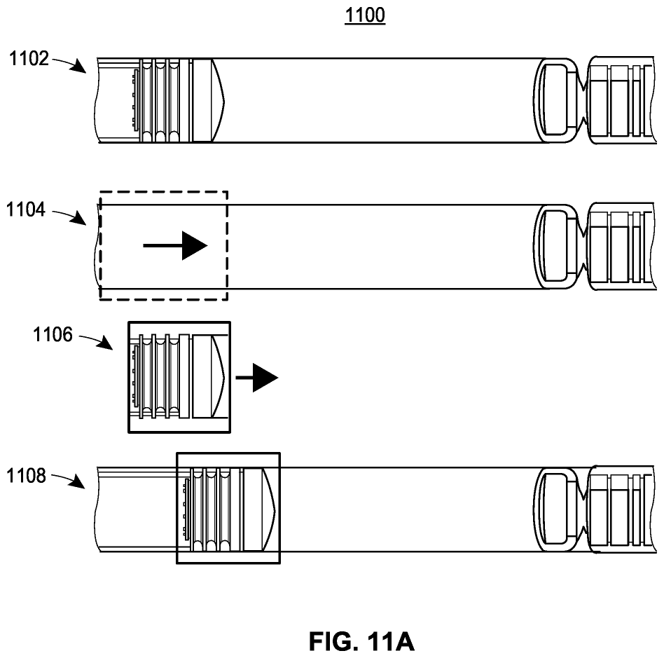

While the various techniques discussed above (e.g., implemented by image pre-processing module 132) may be used to reduce the computation burden and/or computing time required for model training, the quality/accuracy of a trained model, and the ability of a trained model to adapt to different circumstances (e.g., different lots or products) can depend on the diversity of the training image library (e.g., image library 140). System 100 may employ one or more techniques to ensure adequate library diversity, as will now be discussed with respect to FIGS. 10 through 13.

FIG. 10 shows a technique 1000 that may be used to check whether an assembled library has sufficient diversity. Technique 1000 may be implemented by software (e.g., module 134) of computer system 104, for example. In technique 1000, at an initial stage 1002, computer system 104 collects (e.g., requests and receives) images from a training library (e.g., image library 140) for analysis. The images may be only non-defect images, only defect images, only images pertaining to a specific defect class, or some mix thereof, for example. At stage 1004, for each collected image, computer system 104 uses any suitable image processing means to determine/measure a particular metric for which variability/diversity is advantageous (e.g., plunger depth/height/position). The measurement may be made by counting pixels, for example.

At stage 1006, computer system 104 plots the metric depth/height versus syringe image number, and at stage 1008, computer system 104 generates a histogram showing how many images fall into each of a number of bins, where each bin is associated with a particular plunger depth/height (or a particular range thereof). In some embodiments, computer system 104 generates a display with the graph of stage 1006 and/or the histogram of stage 1008, for display to a user (e.g., via a display screen of computer system 104 that is not shown in FIG. 1). The user may then decide whether the displayed graph and/or histogram represents sufficient diversity. Alternatively, computer system 104 may use a threshold (e.g., a threshold min-to-max span, a threshold standard deviation, etc.) or some other suitable algorithm to automatically determine whether the variability/diversity is sufficiently similar to what may be encountered during production. Similar techniques may also, or instead, be used with respect to one or more other container features that have variable positions (e.g., any of features 902, 904, 906 or 908 in FIG. 9A). With a sufficiently large pool of images to draw from, such techniques may also be used to create smaller image sets with carefully blended characteristics, as best suits a particular application.

While FIG. 10 illustrates a technique that can be used to confirm the diversity of a training (and/or validation) image library such as image library 140, other techniques may be used to actively increase the size and diversity of image library 140. In particular, automated image augmentation and/or image synthesis techniques may be used to artificially expand the level of diversity exhibited by a collection of “real-world” container images. These techniques can be particularly useful in the pharmaceutical context, where generating the “defect” samples needed for both training and validating neural networks generally requires slow and skillful manual labor. Moreover, many of the variable container features discussed above (e.g., any of syringe features 902 through 908, or variable features of cartridges or vials) can vary in tandem, requiring a fully robust training and test image libraries to cover most or all possible permutations of the feature set. These factors can combine to make the generation of large, diverse image libraries prohibitively time-consuming and/or costly. However, the following techniques can be used to provide a library enhancement framework that is specifically crafted to work well within the constraints of a pharmaceutical application, and to substantially reduce the burden of manually generating large and diverse volumes of training data. Moreover, the library enhancement framework can potentially improve model classification accuracy and/or reduce the likelihood of a model “overfilling” on the training data. Digital image augmentation for library enhancement can also have other benefits. For example, the deliberate generation and handling of real-world defects is dangerous, as containers and the defects themselves (e.g., glass shards) may be sharp, and/or the containers may need to be broken (e.g., to produce cracks) which may lead to frequent shattering of the containers (e.g., if heating is followed by rapid cooling to form the cracks, or if the container is scored to form airlines or external deposits, etc.). Digital image augmentation can reduce the need for non-standard, manual handling of this sort. Furthermore, digital image augmentation can avoid difficulties involved with the capture of transient defect conditions (e.g., evaporation of a liquid in a container that has a crack or other breach of closure integrity, evaporation of liquid in the ribs of a plunger or piston, degradation of colored or turbid liquid contents over time, etc.).

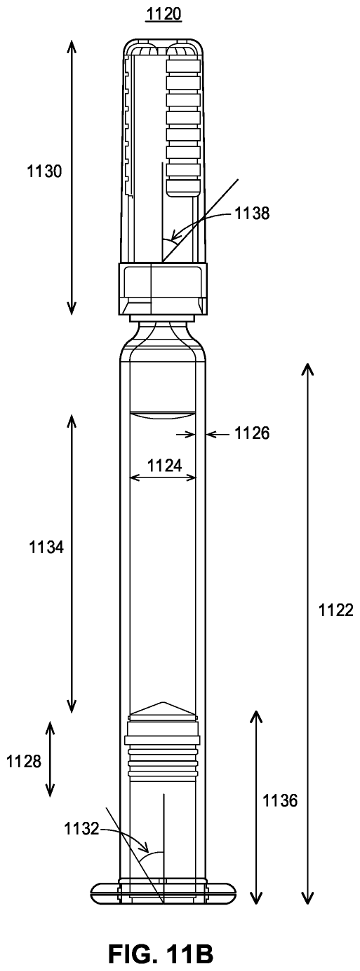

FIG. 11A depicts one example technique 1100 that may be used within such a framework to provide direct augmentation of real-world container images. Technique 1100 may be implemented by library expansion module 134, for example. In technique 1100, at stage 1102, library expansion module 134 obtains a real-world syringe image (e.g., an image generated by visual inspection system 102 and/or stored in image library 140 or memory unit 114). Alternatively, the original image obtained at stage 1102 may be an image that was already augmented (e.g., by previously applying the technique 1100 one or more times).

Next, at stage 1104, library expansion module 134 detects the plunger within the syringe. In some embodiments or scenarios (e.g., if it is known that all real-world syringe images used for training have a plunger at the same, fixed position), stage 1104 only requires identifying a known, fixed position within the original syringe image. If the plunger position can vary in the real-world image, however, then stage 1104 may be similar to stage 932 of technique 920 (e.g., using template matching or blob analysis).

At stage 1106, library expansion module 134 extracts or copies the portion of the syringe image that depicts the plunger (and possibly the barrel walls above and below the plunger). Next, at stage 1108, library expansion module 134 inserts the plunger (and possibly barrel walls) at a new position along the length of the syringe. To avoid a gap where the plunger was extracted, library expansion module 134 may extend the barrel walls to cover the original plunger position (e.g., by copying from another portion of the original image). Library expansion module 134 may also prevent other, pixel-level artifacts by applying a low-pass (e.g., Gaussian) frequency-domain filter to smooth out the modified image. Technique 1100 may be repeated to generate new images showing the plunger in a number of different positions within the barrel.

Techniques similar to technique 1100 may be used to digitally alter the positions of one or more other syringe features (e.g., features 902, 906 and/or 908), alone or in tandem with digital alteration of the positioning of the plunger and/or each other. For example, library expansion module 134 may augment a syringe (or other container) image to achieve all possible permutations of various feature positions, using discrete steps that are large enough to avoid an overly large training or validation set (e.g., moving each feature in steps of 20 pixels rather than steps of one pixel, to avoid many millions of permutations). Moreover, techniques similar to technique 1100 may be used to digitally alter the positions of one or more features of other container types (e.g., cartridge or vial features).

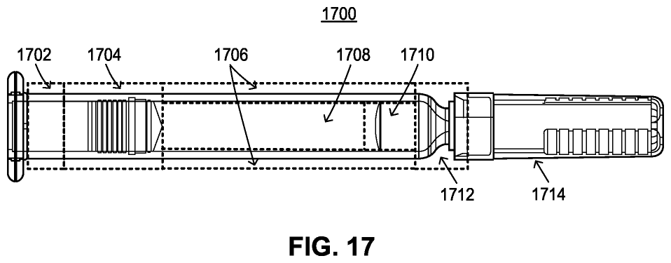

Additionally or alternatively, library expansion module 134 may remove random or pre-defined portions of a real-world container image, in order to ameliorate overreliance of a model (e.g., one or more of the AVI neural network(s)) on certain input features when performing classification. To avoid overreliance on a syringe plunger or cartridge piston, for example, library expansion module 134 may erase part or all of the plunger or piston in the original image (e.g., by masking the underlying pixel values with minimal (0), maximal (255) or random pixel values, or with pixels resampled from pixels in the image that are immediately adjacent to the masked region). This technique forces the neural network to find other descriptive characteristics for classification. Especially when used in conjunction with heatmaps (as discussed below with reference to FIGS. 17 through 19), the technique can ensure that one or more of the AVI neural network(s) is/are classifying defects for the correct reasons.

Library expansion module 134 may also, or instead, modify real-world container images, and/or images that have already been digitally altered (e.g., via technique 1100), in other ways. For example, library expansion module 134 may flip each of a number of source container images around the longitudinal axis of the container, such that each image still depicts a container in the orientation that will occur during production (e.g., plunger side down), but with any asymmetric defects (and possibly some asymmetric, non-defective characteristics such as bubbles) being moved to new positions within the images. As another example, library expansion module 134 may digitally alter container images by introducing small rotations and/or lateral movements, in order to simulate the range of movement one might reasonably expect due to the combined tolerances of the fixtures and other components in a production AVI system.

FIG. 11B depicts a set 1120 of features that library expansion module 134 may digitally alter, for the example case of syringe images. As seen in FIG. 11B, the feature set 1120 may include barrel length 1122, barrel diameter 1124, barrel wall thickness 1126, plunger length 1128, needle shield length 1130, syringe or barrel angle 1132, liquid height 1134, plunger depth 1136, and/or needle shield angle 1138. In other embodiments, library expansion module 134 may alter more, fewer, and/or different features, such as gripper position (e.g., how far the gripping mechanism extends onto the barrel), gripper rotation, barrel rotation, needle shield rotation, position along the x and/or y axis of the image, overall (or background) brightness level, and so on. It is understood that similar features, or different features not included on syringes, may be varied for other types of containers (e.g., for cartridges, the barrel length/diameter/rotation and/or the piston length/depth, or for vials, the body length/diameter/rotation and/or the length of neck exposed by the crimp, etc.).

For any of the image augmentation techniques discussed above, care must be taken to ensure that the digital transformations do not cause the label of the image (for supervised learning purposes) to become inaccurate. For example, if a “defect” image is modified by moving a plunger (or piston, etc.) to a position that entirely obscures a fiber or other defect within the container, or by low-pass filtering or erasing a portion of the image in a manner that obscures a particle or other defect, the image may need to be re-labeled as “good.”

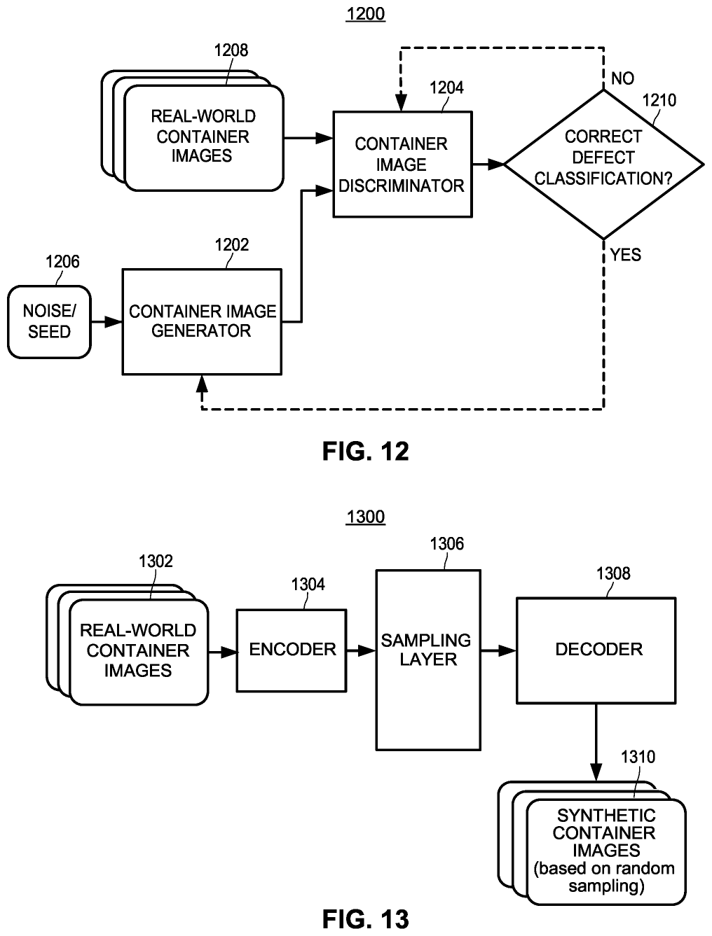

FIGS. 12 and 13 depict examples of techniques that may be used to generate synthetic container images using deep generative models. In these embodiments, rather than (or in addition to) the above techniques for directly augmenting container images, advanced deep learning techniques may be used to generate new images. The techniques of FIG. 12 and/or FIG. 13 may be implemented by library expansion module 134, for example.

Referring first to FIG. 12, an example technique 1200 generates synthetic container images using a generative adversarial network (GAN). In this embodiment, the GAN operates by training a container image generator 1202 to generate realistic container mages, while also training a container image discriminator 1204 to distinguish real container images (i.e., images of real-world containers) from synthetic container images (e.g., images generated by generator 1202). In effect, generator 1202 and discriminator 1204 are trained by “competing” with each other, with generator 1202 trying to “fool” discriminator 1204. Generator 1202 may include a first neural network, and discriminator may include a second neural network. For example, generator 1202 may be a deconvolutional neural network, and discriminator 1204 may be a convolutional neural network.

The GAN operates by inputting container images to discriminator 1204, where any given image may be one of a number of different real-world container images 1208 (e.g., images captured by visual inspection system 102, and possibly cropped or otherwise processed by image pre-processing module 132), or may instead be one of a number of different synthetic container images generated by generator 1202. To generate an array of different container images, the neural network of generator 1202 is seeded with noise 1206 (e.g., a random sample from a pre-defined latent space).

For each image input to discriminator 1204, discriminator 1204 classifies the image as either real or synthetic. Because it is known whether a real image 1208 or a synthetic image was input to discriminator 1204, supervised learning techniques can be used. If it is determined at stage 1210 that discriminator 1204 correctly classified the input image, then generator 1202 failed to “fool” discriminator 1204. Therefore, feedback is provided to the neural network of generator 1202, to further train its neural network (e.g., by adjusting the weights for various connections between neurons). Conversely, if it is determined at stage 1210 that discriminator 1204 incorrectly classified the input image, then generator 1202 successfully fooled discriminator 1204. In this case, feedback is instead provided to the neural network of discriminator 1204, to further train its neural network (e.g., by adjusting the weights for various connections between neurons).

By repeating this process for a large number of real-world container images 1208 and a large number of synthetic images from generator 1202, both the neural network of discriminator 1204 and the neural network of generator 1202 can be well trained. In the case of generator 1202, this means that library expansion module 134 can randomly seed generator 1202 to generate numerous synthetic container images that may be added to image library 140 for training and/or validation by AVI neural network module 116. The generated artificial/synthetic images may vary in one or more respects, such as any of various kinds of defects (e.g., stains, cracks, particles, etc.), and/or any non-defect variations (e.g., different positions for any or all of features 902 through 908 and/or any of the features in set 1120, and/or the presence of bubbles, etc.). In some embodiments, library expansion module 134 seeds particle locations (e.g., randomly or specifically chosen locations) and then uses a GAN to generate realistic particle images.

In some embodiments, library expansion module 134 trains and/or uses a cycle GAN (or “cycle-consistent GAN”). With a cycle GAN, as with the GAN of FIG. 12, the generator learns what image characteristics represent a class by repeatedly presenting instances to a discriminator and adjusting the representations of the generator accordingly. With a cycle GAN, however, a second discriminator is introduced, allowing the cycle GAN to learn to map/transform one class of image to another class of image. Thus, for example, the generator of a cycle GAN can transform a large number of non-defect, real-world container images (which as noted above are generally easier to obtain than defect images) to images that exhibit a particular class of defects. These transformed images can be added to image library 140 to expand the training and/or validation data. Moreover, the transformed images may help any of the neural network(s) that module 116 trains with those images to be less biased towards underlying non-defect representations. For example, an AVI neural network trained on a particular set of real-world images might mistakenly classify non-defects as defects based upon some lighting artificiality. If that same neural network were trained not only on those images, but also on versions of (at least some of) those images that are first transformed to exhibit defects, the classifier can be trained to make an inference based on the defect itself and not the lighting artificiality.

Referring next to FIG. 13, an example technique 1300 generates synthetic container images using a variational autoencoder (VAE). VAEs can be easier to work with than GANs and, because they are particularly well suited for highly-structured data, and can work particularly well in pharmaceutical applications in which container images for the most part have fixed features (i.e., other than variations due to factors such as tolerances and defects). With a VAE, an input container image (from real-world container images 1302, e.g., as generated by visual inspection system 102) is encoded by an encoder 1304 into a low-dimensional latent space (sampling layer 1306) that is represented through statistical means, and then decoded by a decoder 1308 back into an output image that corresponds to a point in that randomly-distributed latent space. For a given one of real-world container images 1302, encoder 1304 determines what minimal information is needed to represent the image via compression in sampling layer 1306, and decoder 1308 uses that minimal information (i.e., the corresponding point in sampling layer 1306) to reconstruct the image. Encoder 1304 and decoder 1308 may both be neural networks, for example. The reconstructed images that correspond to the same points in sampling layer 1306 as real-world container images 1302 are not shown in FIG. 13. To generate synthetic container images 1310 from one of real-world container images 1302, library expansion module 134 can randomly sample the latent space (sampling layer 1306) for the real-world container image 1302, and run that sample through the trained decoder 1308.

Output images from a VAE can also be useful by providing an indication of the “mean” image from among images in its class, such that features that can vary from image to image appear according to the frequency of those features in the dataset. Thus, for example, the amount of syringe sidewall movement or plunger movement in image library 140 can be visualized by observing the “shadows” or blurring in a synthesized image, with thicker shadows/blurring indicating a larger range of positional variability for that feature.

In general, deep generative models such as those discussed above can enable the generation of synthetic images where key parameters (e.g., plunger position, meniscus, etc.) are approximately constrained, by feeding artificially generated “seed” images into a trained neural network.

As noted above, a large and diverse training image library, covering the variations that may be expected to occur in production (e.g., defects having a different appearance, container features having a tolerance range, etc.), can be critical in order to train a neural network to perform well. At the same time, if any of the potential image-to-image variations can be reduced or avoided, the burdens of generating a diverse training image library are reduced. That is, the need to include certain types of variations and permutations in the training library (e.g., image library 140) can be avoided. In general terms, the more a visual inspection system is controlled to mitigate variations in the captured images, the smaller the burden on the training phase and, potentially, the greater the reduction in data acquisition costs.

Container alignment is one potential source of variation between container images that, unlike some other variations (e.g., the presence/absence of defects, different defect characteristics, etc.), is not inherently necessary to the AVI process. Alignment variability can arise from a number of sources, such as precession of the container that pivots the container around the gripping point (e.g., pivoting a syringe around a chuck that grips the syringe flange), squint of the container, differences in camera positioning relative to the container fixture (e.g., if different camera stations are used to assemble the training library), and so on. In some embodiments, techniques are used to achieve a more uniform alignment of containers within images, such that the containers in the images have substantially the same orientation (e.g., the same longitudinal axis and rotation relative to the image boundaries).

Preferably, mechanical alignment techniques are used as the primary means of providing a consistent positioning/orientation of each container relative to the camera. For example, gripping fingers may be designed to clasp the syringe barrel firmly, by including a finger contact area that is long enough to have an extended contact along the body/wall of the container (e.g., syringe barrel), but not so long that the container contents are obscured from the view of the camera. In some embodiments, the fingers are coated with a thin layer of rubber, or an equivalent soft material, to ensure optimal contact with the container.

Even with the use of sound mechanical alignment techniques, however, slight variations in container alignment within images may persist (e.g., due to slight variations between containers, how well seated a container is in a conveyance fixture, “stack-up” tolerance variations between sequential fixtures, and/or other factors). To mitigate these remaining variations, in some embodiments, digital/software alignment techniques may be used. Digital alignment can include determining the displacement and/or rotation of the container in the image (and possibly the scale/size of the imaged container), and then resampling the image in a manner that corrects for the displacement and/or rotation (and possibly adjusting scale). Resampling, especially for rotation, does come with some risk of introducing pixel-level artifacts into the images. Thus, as noted above, mechanical alignment techniques are preferably used to minimize or avoid the need for resampling.

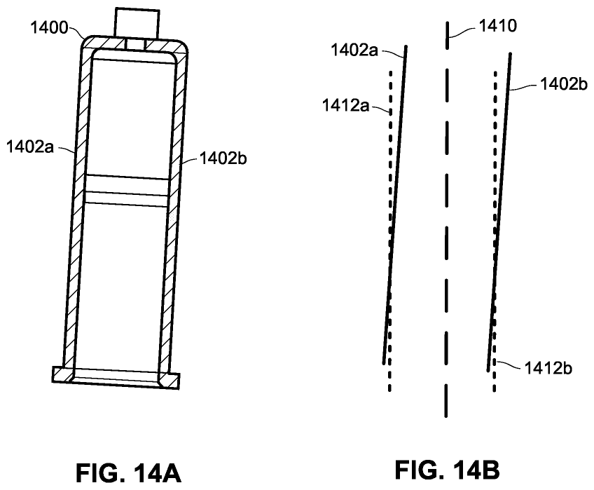

FIGS. 14A and 14B depict an example technique for correcting alignment of a container 1400 within an image, which may be implemented by image pre-processing module 132, for example. In some embodiments, as noted above, the technique is only intended to correct for small misalignments (e.g., up to a few degrees of tilt). In FIGS. 14A and 14B, however, a relatively large degree of misalignment is shown for purposes of clarity. Referring first to FIG. 14A, container 1400 (e.g., container 214 or 406), with a wall having left and right edges (from the perspective of the camera) 1402a and 1402b, is imaged by a camera. FIG. 14A may represent container 1400 as imaged by camera 202, one of cameras 302a through 302c, or one of cameras 402a through 402c, for example. Referring next to FIG. 14B, module 132 may detect the edges 1402a and 1402b using any suitable edge detection technique, and may output data indicative of the positions of edges 1402a and 1402b (e.g., relative to a center line 1410, corner, or other portion of the entire image). In FIG. 14B, reference lines 1412a and 1412b may represent expected edge locations (e.g., as stored in memory unit 114), which should also correspond to the corrected positions of edges 1402a and 1402b, respectively.

In the depicted scenario, edges 1402a and 1402b are positively offset from reference lines 1412a and 1412b along both the x-axis and y-axis (i.e., towards the right side, and towards the top, of FIG. 14B), and are rotated by about 10 degrees around the z-axis, relative to reference lines 1412a and 1412b. Module 132 may measure the precise offsets (e.g., in pixels) and rotation (e.g., in degrees), and use those values to compute correction data (e.g., a correction matrix) for the image. Module 132 may then apply the correction data to resample the image, with container 1400 being substantially aligned in the corrected image (e.g., with edges 1402a and 1402b aligning with reference lines 1412a and 1412b, respectively).

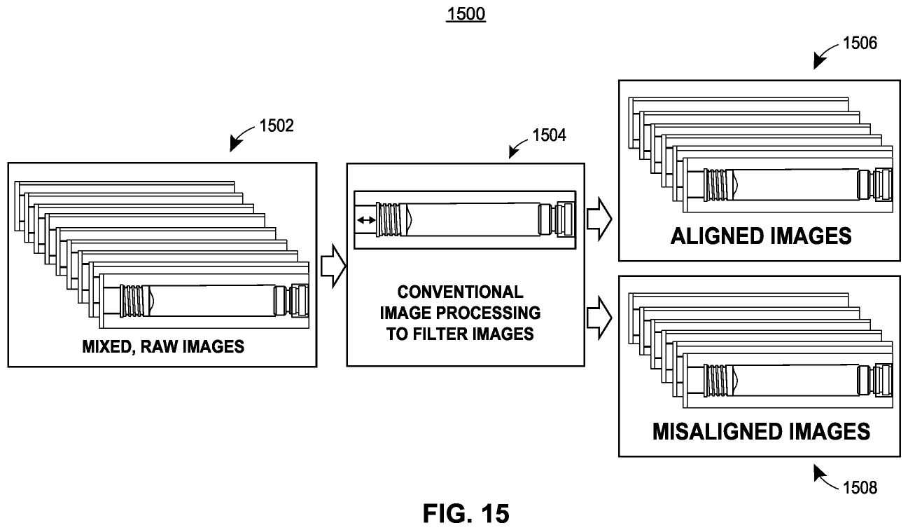

In some embodiments, image pre-processing module 132 determines the positioning/orientation of containers within images not only for purposes of digitally aligning images, but also (or instead) to filter out images that are misaligned beyond some acceptable level. One example filtering technique 1500 is shown in FIG. 15. In technique 1500, at stage 1502, module 132 collects container images (e.g., images generated by visual inspection system 102). At stage 1504, module 132 processes the collected images to detect offsets and rotations (e.g., as discussed above in connection with FIGS. 14A and 14B). Stage 1504 may also include comparing the offsets and rotations to respective acceptability thresholds, or comparing one or more metrics (derived from the offsets and/or rotations) to acceptability thresholds. The threshold(s) may correspond to a level of misalignment beyond which the risk of significant image artifacts (when correcting for the misalignment) is too high, for example. Alternatively, the acceptability threshold(s) may be set so as to mimic real-world production tolerances.

In embodiments that utilize digital alignment techniques, module 132 corrects for the misalignment of images that exhibit some lateral offset and/or rotation, but are still within the acceptability threshold(s). At stage 1506, module 132 causes computer system 104 to store acceptable images (i.e., images within the acceptability threshold(s), after or without correction) in image library 140. At stage 1508, module 132 flags images outside of the acceptability threshold(s). Computer system 104 may discard the flagged images, for example. As with the technique of FIGS. 14A and 14B, filtering out misaligned container images helps to avoid situations in which a neural network is trained to focus on features that are irrelevant to the presence of defects.

While discussed above in relation to creating a training and/or validation image library, it is understood that the alignment and/or filtering techniques of FIGS. 14 and 15 may also be used in production. For example, a module similar to module 132 may correct for slight misalignments of container images prior to inferencing by the trained AVI neural network(s), and/or may flag container images that are misaligned beyond some acceptability threshold(s) as rejects (or as requiring further inspection, etc.). In production, however, digital alignment techniques may be undesirable due to increased false positive rates (i.e., increased reject rates for “healthy” product). Nonetheless, the edge detection and thresholding techniques may be used for fabrication, adjustment and/or qualification of a production AVI system, to ensure that the fixturing of containers relative to the camera(s) is correct and consistent.

Any of the techniques described above may be used to create a training image library that is large and diverse, and/or to avoid training AVI neural network(s) to key on container features that should be irrelevant to defect detection. Nonetheless, it is important that the trained AVI neural network(s) be carefully qualified. Validation/testing of the trained AVI neural network(s), using independent image sets, is a critical part of (or precursor to) the qualification process. With validation image sets, confusion matrices may be generated, indicating the number and rate of false positives (i.e., classifying as a defect where no defect is present) and false negatives (i.e., classifying as non-defective where a defect is present). While confusion matrices are valuable, however, they offer little insight into how the classifications are made, and therefore are not sufficient for a robust and defensible AVI process. When considering an entire container and its contents, there are numerous potential sources of variation in the images being classified, beyond the defect class under consideration (e.g., as discussed in connection with FIGS. 9A and 11B). For example, if “good” and “defect” training and validation images on average exhibit a slight difference in the position/height of the meniscus, the neural network can be trained to discriminate good/defective images based on meniscus level, even if meniscus level should in theory have no bearing on the type(s) of defect being considered (e.g., particles, cracks, etc.). In such a case, while conventional validation results (e.g., a confusion matrix) may suggest that a model is performing well, the model may not perform well for production images in which the presence of defects is not necessarily correlated to meniscus height. The variability of such correlations across lots can arise due to lot-to-lot differences in parameters such as total liquid fill volume, air gap size, container dimensions, and/or plunger placement during fill, any of which might combine to determine the final position of the meniscus and plunger during inspection.

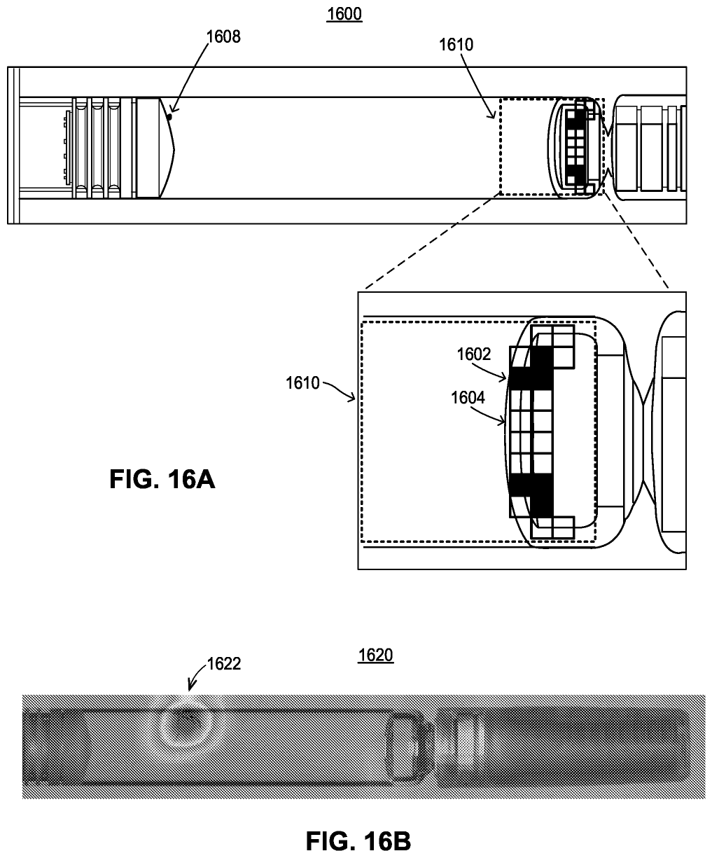

In addition, deep learning models can be fooled by anomalies associated with alignment of the part (e.g., as discussed above). As such, it is critical that the AVI neural network(s) not only correctly reject defective samples, but also that the AVI neural network(s) reject defective samples for the correct reasons. To this end, various techniques that make use of neural network heatmaps may be used, and are discussed now with reference to FIGS. 16 through 18. One or more of the following techniques may be implemented by AVI neural network module 116 and/or neural network evaluation module 136 of computer system 104, for example.

The “heatmap” (or “confidence heatmap”) for a particular AVI neural network that performs image classification generally indicates, for each portion of multiple (typically very small) portions of an image that is input to that neural network, the importance of that portion to the inference/classification that the neural network makes for that image (e.g., “good” or “defect”). In some embodiments, “occlusion” heatmaps are used. In order to generate such a heatmap, AVI neural network module 116 masks a small portion of the image, and resamples the masked portion from surrounding pixels to create a smooth replacement. The shape and size (in pixels) of the mask may be varied as a user input. Module 116 then inputs the partially-masked image into the neural network, and generates an inference confidence score for that version of the image. Generally, a relatively low confidence score for a particular inference means that the portion of the image that was masked to arrive at that score has a relatively high importance to the inference.

Module 116 then incrementally steps the mask across the image, in a raster fashion, and generates a new inference confidence score at each new step. By iterating in this manner, module 116 can construct a 2D array of confidence scores (or some metric derived therefrom) for the image. Depending on the embodiment, module 116 (or other software of computer system 104, such as module 136) may represent the array visually/graphically (e.g., by overlaying the indications of confidence scores on the original image, with a color or other visual indication of each score appearing over the region of the image that was masked when arriving at that score), or may be processed without any visualization of the heatmap.

In other embodiments, module 116 constructs heatmaps in a manner other than that described above. For example, module 116 may generate a gradient-based class activation mapping (grad-CAM) heatmap for a particular neural network and container image. In this embodiment, the grad-CAM heatmap indicates how each layer of the neural network is activated by a particular class, given an input image. Effectively, this indicates the intensity of the activation of each layer for that input image.

FIG. 16A depicts a simplistic representation of an example heatmap 1600 for a container image. Heatmap 1600 may be generated by AVI neural network module 116, using the iterative masking (occlusion) technique or grad-CAM as discussed above, or another suitable heatmap technique. For clarity, FIG. 16A shows heatmap 1600 as including only three levels of confidence scores: a first level, represented by black-filled boxes 1602, indicating that the region has a relatively high importance to the inference (e.g., for an occlusion heatmap, where masking that image portion results in a very low confidence score relative to the score when no masking occurs), a second level, represented by boxes 1604 with no fill, indicating that the region has a moderately high importance to the inference (e.g., for an occlusion heatmap, where masking that image portion results in a moderately lower confidence score relative to the score when no masking occurs), and a third level (represented by no box at all) indicating that the region has a low importance to the inference (e.g., for an occlusion heatmap, where masking that image portion results in a confidence score that is not significantly lower than the confidence score when no masking occurs). It is understood, however, that the simplicity of heatmap 1600 in FIG. 16A is exaggerated for clarity, and that heatmap 1600 can instead indicate far more levels or ranges of importance of each image portion (e.g., using a nearly continuous range of colors and/or shades to represent the levels of importance to the inference). Moreover, while each image portion (box 1602 or 1604) in FIG. 16A is shown as being relatively large for clarity, in other embodiments module 116 generates heatmap 1600 using a smaller mask size, and/or a different mask shape. A more realistic heatmap 1620 (in this case, produced using grad-CAM) is shown in FIG. 16B, in a scenario where the heatmap is heavily (and correctly) focused on a crack 1622 in a wall of the syringe barrel.

Returning now to the example scenario of FIG. 16A, the container image should be a “defect” image due to the presence of a heavy particle 1608 on the plunger dome. However, heatmap 1600 indicates that the neural network instead made its inference based primarily on the portion of image 1600 depicting the fluid meniscus within the syringe barrel. If (1) module 116 presents heatmap 1600 (overlaid on the container image) to a user, along with an indication that a particular neural network classified the container image as a “defect,” and (2) the user knows that the particular neural network is trained specifically to detect defects associated with the plunger dome, the user can readily determine that the neural network correctly classified the image, but for the wrong reason. By analyzing a sufficiently large number of heatmaps and the corresponding classifications/inferences, the user may be able to determine with some level of confidence whether that particular neural network is classifying images for the right reasons.

This process can be extremely time consuming, however. Accordingly, in some embodiments, neural network evaluation module 136 automatically analyzes heatmaps and determines whether a neural network is classifying images for the right reasons. To accomplish this, module 136 examines a given heatmap (e.g., heatmap 1600) generated by a neural network that is trained to detect a particular class of defects, and determines whether the portions of the image that were most important to a classification made by that neural network are the portions that should have been relied upon to make the inference. In FIG. 16A, for example, module 136 may determine that the portions of the image most important to a “defect” classification (e.g., as indicated by boxes 1602 and 1604) are within a container zone 1610, where container zone 1610 encompasses a range of positions in which the meniscus is expected to be seen. Because zone 1610 does not encompass any part of the plunger, module 136 can flag the classification as an instance in which the neural network made the classification for the wrong reason. Conversely, for the example of FIG. 16B, module 136 may determine that the portions of the image most important to a “defect” classification are within the expected container zone (e.g., a zone that includes some or all of the syringe barrel), and therefore does not flag the classification as being made for the wrong reason.

This technique may be particularly apt in embodiments where the AVI neural networks include a different neural network trained to detect each of a number of different defect classes, which are in turn associated with a number of different container zones. One example breakdown of such zones is shown in FIG. 17. In FIG. 17, an example container 1700 (here, a syringe) is associated with a zone 1702 in which defects associated with the base of the syringe barrel (e.g., cracks or chips in the syringe barrel, open internal airlines in the barrel wall, stains, dirt, or other foreign matter on the internal surface of the barrel, internal bruises over a threshold size/area, such as >0.225 mm², etc.) would be expected, a zone 1704 in which defects associated with the plunger (e.g., misshapen plungers, stains or heavy particles on the plunger dome, etc.) would be expected, a non-contiguous zone 1706 in which defects associated with the main portion of the syringe barrel (e.g., open internal airlines, chips, internal or external adhered/sintered/fused glass particles, foreign objects on the internal surface of the barrel wall, etc.) would be expected, a zone 1708 in which defects associated with the syringe barrel (e.g., cracks, stains, particles, etc.) would be expected, a zone 1710 in which defects associated with the meniscus (e.g., particles floating upon the meniscus) would be expected, a zone 1712 in which defects associated with the needle shield and shoulder area of the syringe (e.g., shield-to-shoulder clearance/gap too large, cracks, internal stains or chips in the syringe shoulder or neck, fibers or other particles within the syringe near the syringe shoulder, etc.) would be expected, and a zone 1714 in which defects associated with the needle shield (e.g., missing or bent needle shield) would be expected. In one embodiment, for example, the neural networks trained and/or used by AVI neural network module 116 include at least seven neural networks each trained to detect defects associated with a different one of the seven container zones 1702 through 1714. In some embodiments, one or more zones are also, or instead, associated with particular types of imaging artifacts that should not trigger the rejection of a container. For example, depending on the configuration of the illumination source(s), the syringe walls within zone 1706 may appear as black “strips,” with the thickness of the strips varying depending on whether liquid is present within the syringe.

In general, if neural network evaluation module 136 determines that a particular AVI neural network classifies an image as a “defect” despite the corresponding heatmap showing primary reliance on portions of the image in an unexpected zone (given the defect class for which the neural network was trained), module 136 may flag the classification as an instance in which the neural network made the classification for the wrong reason. Module 136 may keep a count of such instances for each of the AVI neural networks, for example, and possibly compute one or more metrics indicative of how often each of neural networks makes a classification for the wrong reason. Computer system 104 may then display such counts and/or metrics to a user, who can determine whether a particular AVI neural network should be further trained (e.g., by further diversifying the images in image library 140, etc.).

In some embodiments, the relevant container zones (e.g., zones 1702 through 1714) are themselves dynamic. For example, rather than using only pre-defined zones, neural network evaluation module 136 may use any of the object detection techniques described above (in connection with automated image cropping) to determine where certain zones are for a particular container image. In FIG. 17, for example, zone 1710 may encompass a much smaller area that closely bounds the actual meniscus position within the container image, rather than accounting for variability in the meniscus location by using a larger pre-defined zone 1710.

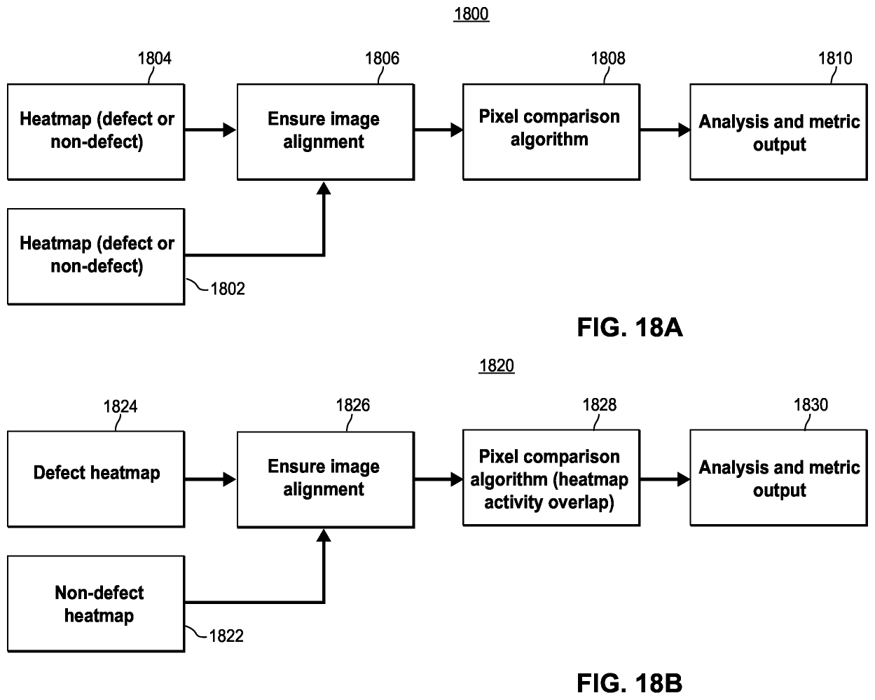

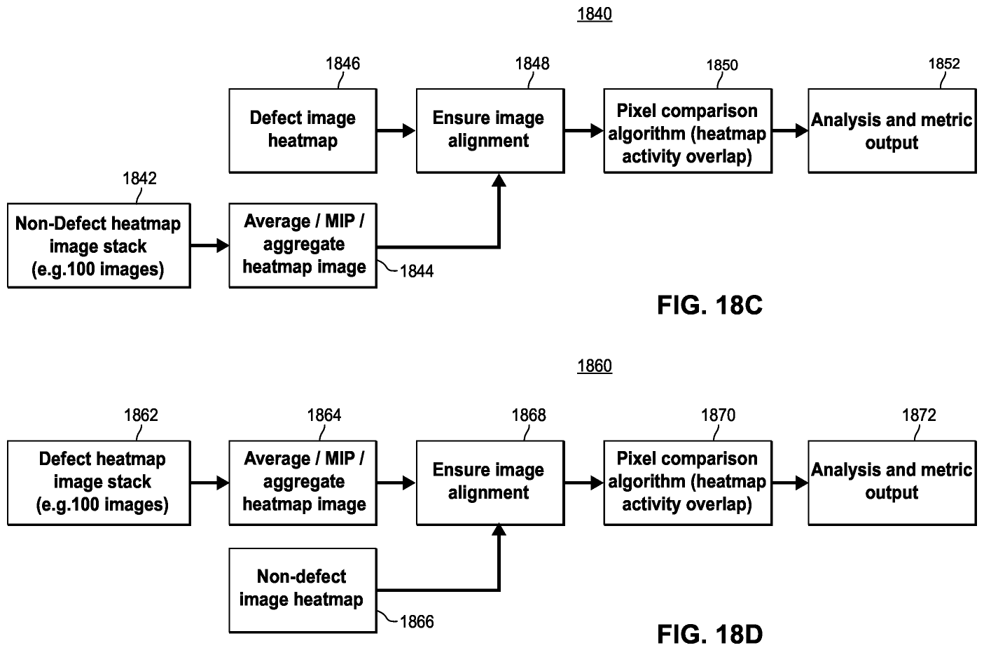

FIG. 18A through 18D depict various example processes for performing automated heatmap analysis. Any or all of these processes may be implemented by AVI neural network module 116 and/or neural network evaluation module 136, for example. Referring first to process 1800 of FIG. 18A, at stage 1802, an expected target region map is generated (e.g., input to computer system 104 by a user, or dynamically determined by module 132 or 136 using object detection). The map defines different container zones, and may be similar to that shown in FIG. 17, for example. At stage 1804, a heatmap is generated (e.g., by training server 116) for a container image run through a neural network that is trained to detect defects of a specific category/class, e.g., when qualifying the neural network. The neural network may infer that the image shows a defect, or does not show a defect, depending on the scenario. At stage 1806, the heatmap generated at stage 1804 and the map generated at stage 1802 are aligned and/or checked for alignment (e.g., by module 136). That is, the heatmap is effectively overlaid on the map, or vice versa, with container zones in the map aligning with the corresponding parts of the heatmap (e.g., zone 1706 of the map aligning with parts of the heatmap that correspond to the container walls).

At stage 1808, pixels of the heatmap are compared (e.g., by module 136) to pixels of the map. Stage 1808 may include comparing heatmap pixel values (indicative of importance of that portion of the image to the inference made by the neural network) to the map, e.g., by determining where the highest pixel values reside in relation to the map. In other embodiments, the comparison at stage 1808 may be done at the mask-size level rather than on a pixel-by-pixel basis. At stage 1810, the results of the comparison are analyzed to generate one or more metrics (e.g., by module 136). The metric(s) may include a binary indicator of whether the highest heatmap activity occurs in the expected zone of the map (given the inference made and the class of defect for which the neural network was trained), or may include one or more metrics indicating a non-binary measure of how much heatmap activity occurs in the expected zone (e.g., a percentage value, etc.). The metric(s) may be displayed to a user (e.g., by module 136 generating a value for display), and/or passed to another software module (e.g., by module 136 generating and transferring to another module data that is used in conjunction with other information to indicate to a user whether the neural network is sufficiently trained), for example.

Turning next to FIG. 18B, a process 1820 compares heatmaps for “defect” images to heatmaps for “good” (non-defect) images, rather than comparing to a map of container zones. At stage 1822, a heatmap of a “good” (non-defect) image (also referred to as a “good heatmap”) is generated. AVI neural network module 116 may generate the good heatmap by running a container image that is known to exhibit no defects through a neural network that is trained to detect defects of a specific category/class. This good heatmap can then act as a reference heatmap for numerous iterations of the process 1820.

At stage 1824, a heatmap is generated (e.g., by module 116) for another container image run through the same neural network. In this example, the neural network infers that the image shows a defect. At stage 1826, the heatmap generated at stage 1824 and the good heatmap generated at stage 1822 are aligned and/or checked for alignment (e.g., by module 136). That is, one heatmap is effectively overlaid on the other, with corresponding parts of the heatmaps (e.g., for the container walls, plunger, etc.) aligning with each other.

At stage 1828, pixels of the two heatmaps are compared to each other (e.g., by module 136). Stage 1828 may include comparing heatmap pixel values (indicative of importance of that portion of the image to the inference made by the neural network) to each other, for example. In other embodiments, the comparison at stage 1828 may be done at the mask-size level rather than on a pixel-by-pixel basis. At stage 1830, the results of the comparison are analyzed to generate one or more metrics (e.g., by module 136). The metric(s) may include a binary indicator of whether the primary clusters of heatmap activity overlap too much (e.g., greater than a threshold amount) or are suitably displaced, or may include one or more metrics indicating a non-binary measure of how much overlap exists in the heatmap activity (e.g., a percentage value, etc.). The metric(s) may be displayed to a user (e.g., by module 136 generating a value for display), and/or passed to another software module (e.g., by module 136 generating and transferring to another module data that is used in conjunction with other information to indicate to a user whether the neural network is sufficiently trained), for example.

A potential problem with the approach of process 1820 is that single container images, including any image used to obtain the good/reference heatmap, may contain outliers, thereby skewing all later comparisons with defect image heatmaps. To ameliorate this problem, an alternative process 1840 shown in FIG. 18C generates a “composite” heatmap. In process 1840, at stage 1842, a stack/collection of N (e.g., 10, 100, 1000, etc.) good heatmaps is generated by running images that are known to depict different defect-free containers/samples through a neural network trained to detect defects in a particular defect class (e.g., by module 116). At stage 1844, a composite heatmap is generated (e.g., by module 136) based on the stack of N good heatmaps. For example, module 136 may generate the composite heatmap by averaging, adding, or taking the maximum intensity projection (MIP) of heatmap values from the N good heatmaps. Stages 1846, 1848, 1850 and 1852 may then be similar to stages 1824, 1826, 1828 and 1830, respectively, of process 1820.

FIG. 18D illustrates a reciprocal process 1860 for analyzing the reason(s) underlying a “good” classification made by a neural network. In process 1860, at stage 1862, a stack/collection of N (e.g., 10, 100, 1000, etc.) heatmaps of images that are known to depict containers/samples exhibiting defects in a particular defect class (also referred to as “defect heatmaps”) is generated by running the images through a neural network trained to detect defects in that class (e.g., by module 116). At stage 1864, a composite heatmap is generated (e.g., by module 136) based on the stack of N defect heatmaps. Stage 1864 may be similar to stage 1844 of process 1840, for example. At stage 1866, a heatmap is generated (e.g., by training server 116) for another container image run through the same neural network. In this example, the neural network infers that the image shows no defect. Stages 1868, 1870 and 1872 may then be similar to stages 1826, 1828 and 1830, respectively, of process 1820.

The discussion above has primarily focused on the use of neural networks that classify an image (or some cropped portion of an image as in FIG. 8) in its entirety. These neural networks, which are referred to herein as “image classification” neural networks, may perform well using some or all of the techniques discussed above (e.g., techniques for reducing usage of memory/processing resources, library enhancement techniques, qualification techniques, etc.). In alternative embodiments, however, some or all of the neural networks trained and/or used by AVI neural network module 116 may instead perform object detection. As noted above, unless the context clearly indicates a more specific use, “object detection” as used herein (and in contrast to image classification) may broadly refer to any techniques that identify the particular location of an object (e.g., particle) within an image, and/or that identify the particular location of a feature of a larger object (e.g., a crack or chip on a syringe or cartridge barrel, etc.), and can include, for example, techniques that perform segmentation of the container image or image portion (e.g., pixel-by-pixel classification), or techniques that identify objects and place bounding boxes (or other boundary shapes) around those objects.

In embodiments utilizing object detection, the building of image library 140 may be more onerous than for image classification in some respects, as users typically must manually draw bounding boxes (or boundaries of other defined or arbitrary two-dimensional shapes) around each relevant object, or pixel-wise label (e.g., “paint”) each relevant object if the model to be trained performs segmentation, in order to create the labeled images for supervised learning (e.g., when using a labeling tool GUI, such as may be generated by AVI neural network module 116). Moreover, training and run-time operation is generally more memory-intensive and time-intensive for object detection than for image classification. At present, inference times on the order of about 50 ms have been achieved, limiting the container imaging rate to about 20 per second. In other respects, however, object detection may be preferable. For example, while manual labeling of training images is generally more labor- and time-intensive for object detection than for image classification, the former more fully leverages the information contained within a given training image. Overall, the generation of image library 140 may be simplified relative to image classification, and/or the trained neural network(s) may be more accurate than image classification neural networks, particularly for small defects such as small particles (e.g., aggregates or fibers).

With object detection, an AVI neural network is shown what area to focus on (e.g., via a bounding box or other boundary drawn manually using a labeling tool, or via an area that is manually “painted” using a labeling tool), and the neural network returns/generates a bounding box (or boundary of some other shape), or a pixel-wise classification of the image (if the neural network performs segmentation), to identify similar objects. Comparisons between the network-generated areas (e.g., bounding boxes or sets of pixels classified as an object) and the manually-added labels (e.g., bounding boxes or pixels within areas “painted” by a user) can simplify qualification efforts significantly relative to the use of heatmaps (e.g., relative to the techniques discussed above in connection with FIGS. 16 through 18 for image classification). In some embodiments, for example, module 136 (or another module) may automate the process by determining whether any particular areas indicated by data generated by a neural network (e.g., during validation or qualification) correspond to manually-indicated areas for a given container image. With bounding boxes, for example, this may be performed by computing the percentage overlap of the bounding box generated by the neural network with the user-generated (manual label) bounding box (or vice versa), for instance, and comparing the percentage to a threshold (e.g., with a “match” occurring, and indicating correct operation, if there is at least the threshold percentage of overlap). As another example, this may be performed by determining whether the center point of the bounding box generated by the neural network is within a bounding box that was added during labeling (or vice versa). In other embodiments, this comparison of bounding boxes (or other indications of image areas) may be performed manually by a user of a tool that presents both the model-generated area (e.g., model-generated bounding box) and the user-generated area (e.g., user-drawn bounding box) on a display, with both areas overlaid on the container image.

Another potential advantage of object detection is that object detection can be significantly less affected by variability of various unrelated features, as compared to image classification. For example, features such as plunger or piston position, barrel diameter, air gap length, and so on (e.g., any of the syringe features shown in FIG. 9A or FIG. 11B, or similar cartridge or vial features), and image artifacts relating to these features, should have relatively little impact on the ability of an AVI neural network to detect an object (e.g., particle) within the container contents. Thus, image library 140 generally need not exhibit the same range/diversity of image features required for accurate image classification models. In this respect, therefore, the time, cost, and/or processing required to generate image library 140 may be lessened. For example, system 100 may not use library expansion module 134 to build library 140. Alternatively, module 134 may still be used, but only for more limited cases (e.g., using a GAN to generate synthetic container images having particles that vary in size, shape, texture, motion blur, etc.). In some embodiments, a certain amount of variability (in addition to object appearance) may be desirable even with object detection. For example, AVI neural network module 116 may train a neural network to detect particles under both stationary and dynamic (e.g., spinning) conditions. Alternatively, AVI neural network module 116 may train separate object detection neural networks to handle stationary and dynamic conditions.

Object detection (segmentation or otherwise) can also be advantageous due to the coupling between the loss terms that account for classification and location. That is, the model is optimized by balancing the incremental improvement in classification accuracy with that of the predicted object's position and size. A benefit of this coupling is that a global minimum for the loss terms will more likely be identified, and thus there is generally less error as compared to minimizing classification and location loss terms independently.

As discussed above, segmentation or other object detection techniques may also be advantageously used to help crop container images. Because dynamic cropping removes irrelevant image artifacts, it is possible to train on a sample set that is defect-free, or slightly different than what will be tested at run time. Current practices typically require full defect sets to be made for a specific product, such that all combinations of plunger position, meniscus shape, and air gap must be captured for every defect set, which can be extremely cost- and labor-intensive, both to create and to maintain the defect sets. Object detection techniques can significantly reduce this use of resources.

The AVI neural network module 116 may use one or more convolutional neural networks (CNNs) for object detection, for example. In some embodiments, the AVI neural network(s) include only one or more neural networks that are each trained to detect not only objects that trigger rejections (e.g., fibers), but also objects that can easily be confused with the defects but should not trigger rejections (e.g., bubbles). To this end, image library 140 may be stocked not only with images that exhibit a certain object class (e.g., images with fibers, or more generally particles, in the containers), but also images that exhibit the object or feature classes that tend to cause false positives (e.g., images with bubbles of various sizes in the containers). As another example, in some embodiments where AVI neural network module 116 trains a neural network to detect blemishes on the container surface (e.g., scuffs or stains on the barrel or body), module 116 also trains the neural network to detect instances of light reflections/glare off the surface of containers.

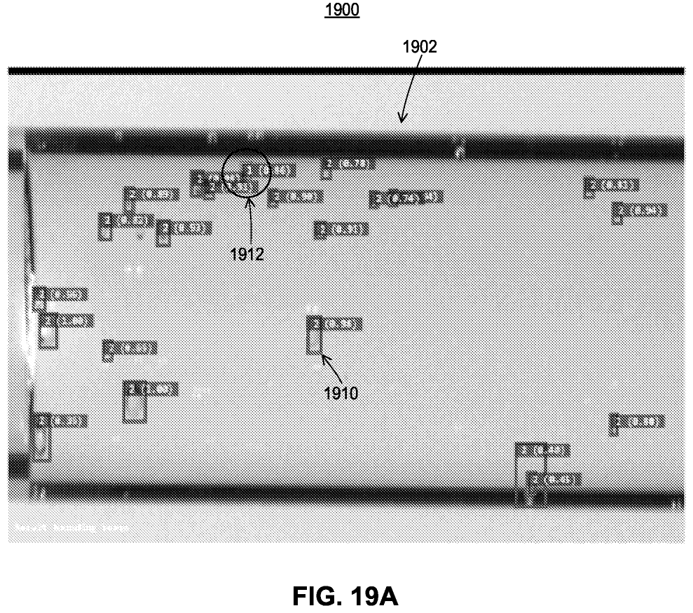

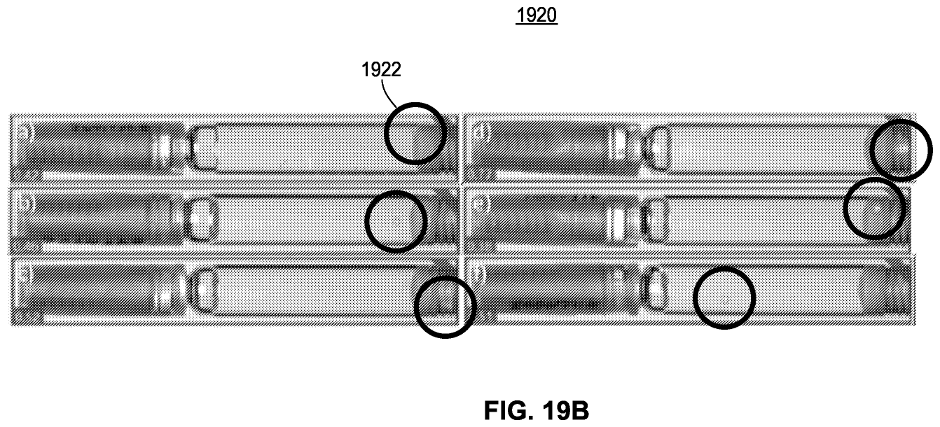

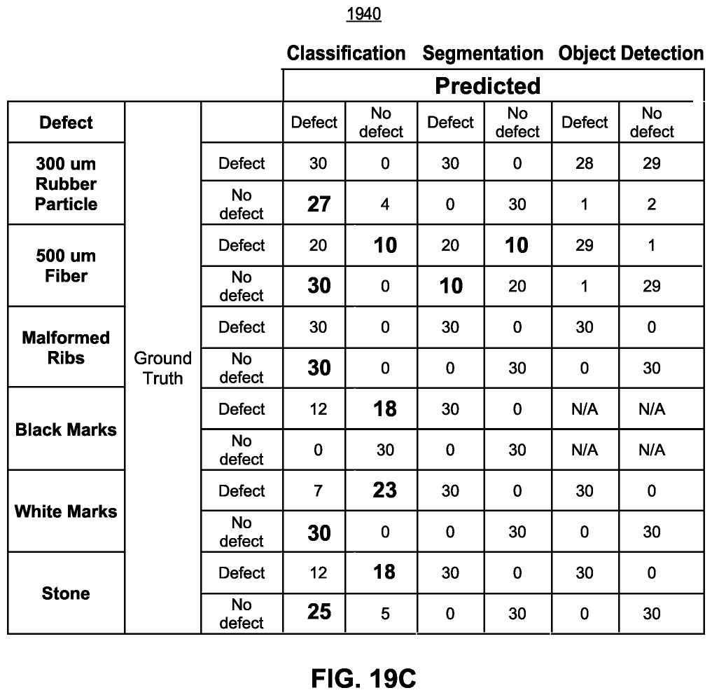

FIG. 19A depicts an example output 1900 of an AVI neural network that is trained to detect both bubbles and non-bubble particles (e.g., fibers) suspended in liquid contents of a container 1902. As seen in FIG. 19A, the neural network outputs a number of bounding boxes 1910 of different sizes, corresponding to detected objects of different sizes. The number next to each bounding box indicates whether the detected object is a bubble (“2”) or a non-bubble particle (“1”), and a confidence score equal to or less than 1.00. In this example, only one detected object 1912 (circled for clarity) is not a bubble (e.g., is a fiber). As seen from this example, it is important that the neural network be trained to consistently and accurately distinguish between bubbles of different sizes (which can be common and plentiful) on the one hand, and foreign particles that can cause a sample to be rejected on the other.

FIG. 19B depicts example outputs 1920 of an AVI neural network that is trained to detect objects by performing segmentation, for six different container images labeled “a” through “f.” As seen in FIG. 19B, the neural network indicates that each of the various pixels of a foreign particle are classified as such. To help show the very small detected particles in FIG. 19B, surrounding circles 1922 are placed in each of the six container images. The pixel-wise indication output by the model provides a straightforward mechanism for ensuring the causality of the defect detection. For example, a viewer can easily see that a feature such as the meniscus did not trigger the object detection.

FIG. 19C depicts a confusion matrix 1940 comparing different defect detection techniques, specifically in regards to performance for various types of conventionally challenging defects (300 μm rubber particle, 500 μm fiber, malformed ribs, black marks, white marks, or stone). In the confusion matrix 1940, “Classification” represents results provided by an image classification technique, “Segmentation” represents results provided by a segmentation technique that classifies individual pixels, and “Object Detection” represents results provided by an object detection technique that places a bounding box/shape around a detected object. Causality of the results shown were verified by visually confirming that the predicted class and heatmap were highlighting the part of the image that contained the defect.

As seen in FIG. 19C, the “Classification” results show that false positives are nearly as big a problem as false negatives for image classification. Conversely, segmentation and other object detection show a significant improvement over image classification in these results, across each defect type tested. Despite the notable improvement in causal predictions over classification, segmentation did not achieve a perfect score for all defects, particularly for the 500 μm fiber. In the image set used, fibers stuck around the meniscus or floating in the solution were not detected by the segmentation technique.

Non-segmentation object detection using bounding boxes (in the right-most columns) also showed a significant improvement over image classification. Even fiber defects were correctly detected a relatively large percentage of the time. To achieve the results shown in FIG. 19C, the object detection model was trained to detect three distinct classes of defects: (1) fibers in suspension or on the syringe wall; (2) fibers stuck on the meniscus; and (3) small bubbles. When the object detection identified a fiber in suspension or on the syringe wall, or a fiber on the meniscus, the syringe was classified as a defect. When the object detection identified only a bubble, or nothing at all, the syringe was classified as good or defect-free. This multi-class approach achieved the best results. Without it, small bubbles were frequently classified as fibers, and fibers stuck on the meniscus were missed.

Because the re-inspection of failed/ejected containers (e.g., syringes) generally must be particularly rigorous, the efficiency of an AVI process is highly dependent on the false positive/false eject rate. Thus, image classification can potentially lead to low efficiency than segmentation or other object detection. However, other techniques described elsewhere herein can help to improve both the false positive and the false negative rate for image classification.

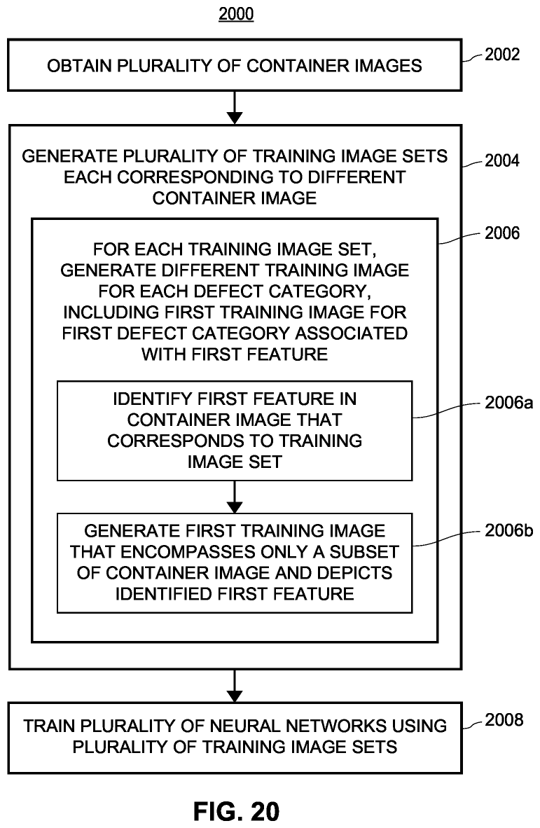

FIGS. 20 through 23 depict flow diagrams of example methods corresponding to some of the techniques described above. In each of FIGS. 20 through 23, “container” may refer to a syringe, cartridge, vial, or any other type of container, and may refer to a container holding contents (e.g., a pharmaceutical fluid or lyophilized product) or an empty container.

FIG. 20 depicts an example method 2000 for reducing the usage of processing resources when training AVI neural networks to perform AVI for respective defect categories, where each defect category is associated with a respective feature of containers or the contents thereof. Method 2000 may be implemented by one or more portions of system 100 (e.g., visual inspection system 102 and computer system 104) or another suitable system. As a more specific example, block 2002 of method 2000 may be implemented by at least a portion of visual inspection system 102 (and/or processing unit 110 when executing instructions of VIS control module 120), block 2004 may be implemented by processing unit 110 when executing instructions of image pre-processing module 132, and block 2008 may be implemented by processing unit 110 when executing instructions of AVI neural network module 116.

At block 2002 of method 2000, a plurality of container images is obtained. Block 2002 may include generating the container images (e.g., by visual inspection system 102 and VIS control module 120), and/or may include receiving the container images from another source (e.g., by VIS control module 120 or image pre-processing module 132, from a server maintaining image library 140), for example.

At block 2004, a plurality of training image sets is generated by processing the container images obtained at block 2002, where each of the training image sets corresponds to a different one of the container images obtained at block 2002. Block 2004 includes, for each training image set, a block 2006 in which a different training image is generated for each of the defect categories. For example, a first feature and a first defect category may be (1) the meniscus within a syringe, cartridge, or vial and (2) particles in or near the meniscus, respectively. As another example, the first feature and first defect category may be (1) the syringe plunger or cartridge piston and (2) a plunger or piston defect and/or a presence of one or more particles on the plunger or piston, respectively. As another example, the first feature and first defect category may be (1) a syringe or cartridge barrel and (2) a presence of one or more particles within the barrel or body, respectively. As yet another example, the first feature and first defect category may be (1) a syringe needle shield or a cartridge or vial cap and (2) an absence of the needle shield or cap, respectively. As still another example, the first feature and first defect category may be (1) lyophilized cake within a vial and (2) a cracked cake, respectively. The first feature and first defect category may be any of the container features and defect categories discussed above in connection with FIG. 8 or FIG. 17, for example.

Block 2006 includes a first block 2006a in which the first feature is identified in the container image corresponding to the training image set under consideration, and a second block 2006b in which a first training image is generated such that the image encompasses only a subset of the container image but depicts at least the first feature. Block 2006a may include using template matching or blob analysis to identify the first feature, for example. Block 2006 (i.e., blocks 2006a and 2006b) may be repeated for every training image set that is generated. In some embodiments, each training image set includes at least one image that is down-sampled and/or encompasses an entirety of the container image that corresponds to that image set.

At block 2008, the plurality of neural networks is trained, using the training image sets generated at block 2004, to (collectively) perform AVI for the plurality of defect categories. Block 2008 may include training each of the neural networks to infer a presence or absence of defects in a different one of the defect categories (e.g., with a different training image in each training image set being used to train each of the neural networks).

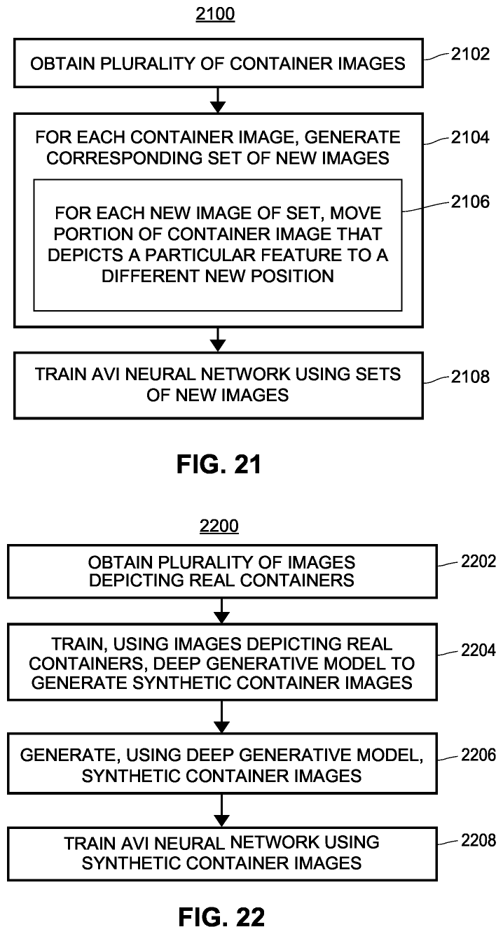

FIG. 21 is a flow diagram of an example method 2100 for training an AVI neural network to more accurately detect defects by expanding and diversifying the training image library. Method 2100 may be implemented by one or more portions of system 100 (e.g., visual inspection system 102 and computer system 104) or another suitable system. As a more specific example, block 2102 of method 2100 may be implemented by at least a portion of visual inspection system 102 (and/or processing unit 110 when executing instructions of VIS control module 120), block 2104 may be implemented by processing unit 110 when executing instructions of library expansion module 134, and block 2108 may be implemented by processing unit 110 when executing instructions of AVI neural network module 116.

At block 2102, a plurality of container images is obtained. Block 2102 may be similar to block 2102, for example. At block 2104, for each obtained container image, a corresponding set of new images is generated. Block 2104 includes, for each new image of the set, a block 2106 in which a portion of the container image that depicts a particular feature is moved to a different new position. The feature may be any of the container features discussed above in connection with FIG. 8 or FIG. 17, for example. As a more specific example, block 2106 may include shifting the portion of the container image along an axis of a substantially cylindrical portion of the container depicted in the container image (e.g., to digitally shift a plunger or meniscus position). Block 2104 may also include, in addition to block 2106, a block in which each new image of the set is low-pass filtered after moving the portion of the container image to the new position.

At block 2108, the AVI neural network is trained using the sets of new images generated at block 2104. Block 2108 may include training the AVI neural network to infer a presence or absence of defects in a particular defect category, or training the AVI neural network to infer a presence or absence of defects across all defect categories of interest. In some embodiments, block 2108 includes training the AVI neural network using not only the new image sets, but also the container images originally obtained at block 2102.

FIG. 22 is a flow diagram of another example method 2200 for training an AVI neural network to more accurately detect defects by expanding and diversifying the training image library. Method 2200 may be implemented by one or more portions of system 100 (e.g., visual inspection system 102 and computer system 104) or another suitable system. As a more specific example, block 2202 of method 2200 may be implemented by at least a portion of visual inspection system 102 (and/or processing unit 110 when executing instructions of VIS control module 120), blocks 2204 and 2206 may be implemented by processing unit 110 when executing instructions of library expansion module 134, AVI neural network module 116, and/or by another software module stored in memory unit 114, and block 2208 may be implemented by processing unit 110 when executing instructions of AVI neural network 116.

At block 2202 of method 2200, a plurality of images depicting real containers is obtained. Block 2202 may include generating the container images (e.g., by visual inspection system 102 and VIS control module 120), and/or may include receiving the container images from another source (e.g., by VIS control module 120 or image pre-processing module 132 from a server maintaining image library 140), for example.

At block 2204, a deep generative model is trained to generate synthetic container images (i.e., images of virtual, digitally-created containers, and possibly contents of those containers). In some embodiments, the deep generative model is a generative adversarial network (GAN). For example, block 2204 may include applying, as inputs to a discriminator neural network, the images depicting the real containers (and corresponding “real” image labels), as well as synthetic images generated by a generator neural network (and corresponding “fake” image labels). In one embodiment, the GAN is a cycle GAN. Alternatively, the deep generative model may be a variational autoencoder (VAE). For example, block 2204 may include encoding each of the images of real containers into a latent space.

At block 2206, synthetic container images are generated using the deep generative model. Block 2206 may include seeding (e.g., randomly seeding) a respective particle location for each of the synthetic container images. In some embodiments where the deep generative model is a cycle GAN, block 2206 includes transforming images of real containers that are not associated with any defects into images that do exhibit a particular defect class. In some embodiments where the deep generative model is a VAE, block 2206 includes randomly sampling the latent space.

At block 2208, the AVI neural network is trained using the synthetic container images. In some embodiments, block 2208 includes training the AVI neural network using not only the synthetic container images, but also the container images originally obtained at block 2202.

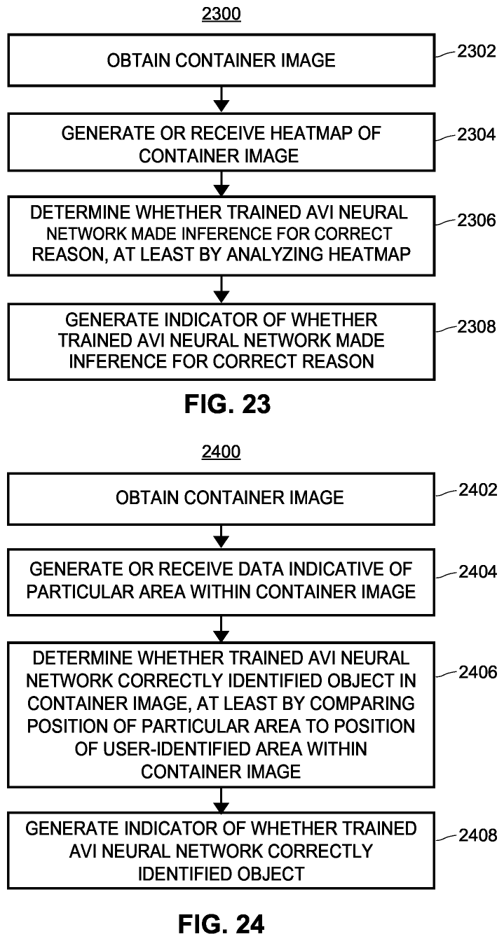

FIG. 23 is a flow diagram of an example method 2300 for evaluating the reliability of a trained AVI neural network that performs image classification. Method 2300 may be implemented by one or more portions of system 100 (e.g., visual inspection system 102 and computer system 104) or another suitable system. As a more specific example, block 2302 of method 2300 may be implemented by at least a portion of visual inspection system 102 (and/or processing unit 110 when executing instructions of VIS control module 120), block 2304 may be implemented by processing unit 110 when executing instructions of AVI neural network module 116 or neural network evaluation module 136, and blocks 2306 and 2308 may be implemented by processing unit 110 when executing instructions of neural network evaluation module 136.

At block 2302, a container image is obtained. Block 2302 may include generating the container image (e.g., by visual inspection system 102 and VIS control module 120), and/or may include receiving the container image from another source (e.g., by VIS control module 120 or image pre-processing module 132, from a server maintaining image library 140), for example.

At block 2304, a heatmap of the container image is generated or received. The heatmap indicates which portions of the container image contributed most to an inference made by the trained AVI neural network, where the inference is an inference of whether the container image depicts a defect. For example, the heatmap may be a two-dimensional array of confidence scores (or of metrics inversely related to confidence scores, etc.), as discussed above in connection with FIG. 16A. In one embodiment, block 2304 includes generating an occlusion heatmap by sequentially, for each image portion of a plurality of different image portions in the container image, (1) masking the image portion, (2) generating a replacement image portion for the masked image portion by resampling based on pixels surrounding the masked image portion, and (3) generating a respective inference confidence score by applying the container image, with the replacement image portion, to the trained AVI neural network. In such an embodiment, the heatmap may include indications of the respective inference confidence scores for the plurality of different image portions. In other embodiments, block 2304 includes generating the heatmap using gradient-weighted class activation mapping (grad-CAM).

At block 2306, the heatmap is analyzed to determine whether a trained AVI neural network made an inference for the container image for the correct reason. In embodiments where the AVI neural network was trained to infer the presence or absence of defects associated with a particular container zone, block 2306 may include generating a first metric indicative of a level of heatmap activity in a region of the heatmap that corresponds to that particular container zone, and comparing the first metric to a threshold value to make the determination, for example. In some embodiments, block 2306 may further include generating one or more other additional metrics indicative of levels of heatmap activity in one or more other regions of the heatmap, corresponding to one or more other container zones, and determining whether the AVI neural network made the inference for the correct reason based on the one or more additional metrics as well as the first metric.

In some embodiments, block 2306 includes comparing the heatmap to a reference heatmap. If the AVI neural network inferred that the container image depicts a defect, for example, block 2306 may include comparing the heatmap to a heatmap of a container image that is known to not exhibit defects, or to a composite heatmap (e.g., as discussed above in connection with FIG. 18C). Conversely, if the AVI neural network inferred that the container image does not depict a defect, block 2306 may include comparing the heatmap to a heatmap of a container image that is known to exhibit a defect, or to a composite heatmap (e.g., as discussed above in connection with FIG. 18D).

At block 2308, an indicator of the determination (i.e., of whether the trained AVI neural network made the inference for the correct reason) is generated. For example, block 2308 may include generating a graphical indicator for display to a user (e.g., “Erroneous basis” or “Correct basis”). As another example, block 2308 may include generating and transferring, to another application or computing system, data that is used (possibly in conjunction with other information) to indicate to a user whether the AVI neural network is sufficiently trained.

FIG. 24 is a flow diagram of an example method 2400 for evaluating the reliability of a trained AVI neural network that performs object detection. Method 2400 may be implemented by one or more portions of system 100 (e.g., visual inspection system 102 and computer system 104) or another suitable system. As a more specific example, block 2402 of method 2400 may be implemented by at least a portion of visual inspection system 102 (and/or processing unit 110 when executing instructions of VIS control module 120), block 2404 may be implemented by processing unit 110 when executing instructions of AVI neural network module 116 or neural network evaluation module 136, and blocks 2406 and 2408 may be implemented by processing unit 110 when executing instructions of neural network evaluation module 136.

At block 2402, a container image is obtained. Block 2402 may include generating the container image (e.g., by visual inspection system 102 and VIS control module 120), and/or may include receiving the container image from another source (e.g., by VIS control module 120 or image pre-processing module 132, from a server maintaining image library 140), for example. At block 2404, data indicative of a particular area within the container image is generated or received. The particular area indicates the position/location of a detected object within the container image, as identified by the trained AVI neural network. The data may be data that defines a bounding box or the boundary of some other shape (e.g., circle, triangle, arbitrary polygon or other two-dimensional shape, etc.), or data that indicates a particular classification (e.g., “particle”) for each individual pixel within the particular area, for example.

At block 2406, the position of the particular area is compared to the position of a user-identified area (i.e., an area that was specified by a user during manual labeling of the container image) to determine whether the trained AVI neural network correctly identified the object in the container image. In some embodiments, block 2406 includes determining whether a center of the particular, model-generated area falls within the user-identified area (or vice versa), or determining whether at least a threshold percentage of the particular, model-generated area overlaps the user-identified area (or vice versa). Block 2406 may then include determining that the object was correctly determined if the center of the model-generated area is within the user-identified area (or vice versa), or if the overlap percentage is at least the threshold percentage, and otherwise determining that the object was incorrectly detected.

At block 2408, an indicator of whether the trained AVI neural network correctly identified the object is generated. For example, block 2408 may include generating a graphical indicator for display to a user (e.g., “Erroneous detection” or “Correct detection”). As another example, block 2408 may include generating and transferring, to another application or computing system, data that is used (possibly in conjunction with other information) to indicate to a user whether the AVI neural network is sufficiently trained.

Although the systems, methods, devices, and components thereof, have been described in terms of exemplary embodiments, they are not limited thereto. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent that would still fall within the scope of the claims defining the invention.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1.-120. (canceled)

121. A method for reducing usage of processing resources when training a plurality of neural networks to perform automated visual inspection for a plurality of respective defect categories, with each of the plurality of respective defect categories being associated with a respective feature of containers or container contents, the method comprising:
obtaining, by one or more processors, a plurality of container images;
generating, by one or more processors processing the plurality of container images, a plurality of training image sets each corresponding to a different one of the plurality of container images, wherein for each training image set,
generating the training image set includes generating a different training image for each of the plurality of respective defect categories,
generating a different training image for each of the plurality of respective defect categories includes generating a first training image for a first defect category associated with a first feature, and
generating the first training image includes
identifying the first feature in the container image that corresponds to the training image set, and
generating the first training image such that the first training image (i) encompasses only a subset of the container image that corresponds to the training image set, and (ii) depicts the identified first feature; and
training, by one or more processors and using the plurality of training image sets, the plurality of neural networks to perform automated visual inspection for the plurality of defect categories.

122. The method of claim 121, wherein training the plurality of neural networks includes training each of the plurality of neural networks to infer a presence or absence of defects in a different one of the plurality of respective defect categories.

123. The method of claim 122, wherein training each of the plurality of neural networks includes, for each of the plurality of training image sets, using a different training image to train a different one of the plurality of neural networks.

124. The method of claim 121, wherein identifying the first feature includes (i) identifying the first feature using template matching, or (ii) identifying the first feature using blob analysis.

125. The method of claim 121, wherein:
(1) the first feature is a meniscus of a fluid within a container, and the first defect category is a presence of one or more particles in or near the meniscus;
(2) the plurality of container images is a plurality of syringe images, and either:
the first feature is a syringe plunger and the first defect category is one or both of (i) a plunger defect or (ii) a presence of one or more particles on the syringe plunger;
the first feature is a syringe barrel and the first defect category is one or both of (i) a barrel defect or (ii) a presence of one or more particles within the syringe barrel;
the first feature is a syringe needle shield and the first defect category is one or both of (i) an absence of the syringe needle shield or (ii) misalignment of the syringe needle shield; or
the first feature is a syringe flange and the first defect category is one or both of (i) a malformed flange or (ii) a defect on the syringe flange;
(3) the plurality of container images is a plurality of cartridge images, and either:
the first feature is a cartridge piston and the first defect category is one or both of (i) a piston defect or (ii) a presence of one or more particles on the cartridge piston;
the first feature is a cartridge barrel and the first defect category is one or both of (i) a barrel defect or (ii) a presence of one or more particles within the cartridge barrel; or
the first feature is a cartridge flange and the first defect category is one or both of (i) a malformed flange or (ii) a defect on the cartridge flange; or
(4) the plurality of container images is a plurality of vial images, and either:
the first feature is a vial body and the first defect category is one or both of (i) a body defect or (ii) a presence of one or more particles within the vial body;
the first feature is a vial crimp and the first defect category is a defective crimp; or
the first feature is a lyophilized cake and the first defect category is a crack or other defect of the lyophilized cake.

126. The method of claim 121, wherein:
generating a different training image for each of the plurality of respective defect categories further includes generating a second training image for a second defect category associated with a second feature; and
generating the second training image includes generating the second training image such that the second training image depicts the second feature.

127. The method of claim 126, wherein generating the second image includes generating the second image by down-sampling at least a portion of the container image that corresponds to the training image set to a lower resolution.

128. The method of claim 126, wherein generating the second training image includes identifying the second feature in the container image that corresponds to the training image set.

129. The method of claim 121, wherein:
generating the plurality of training image sets each corresponding to a different one of the plurality of container images includes digitally aligning at least some of the plurality of container images, at least in part by resampling the at least some of the plurality of container images; and
digitally aligning at least some of the plurality of container images includes (i) detecting an edge within one or more of the plurality of container edges, and (ii) comparing a position of the detected edge to a position of a reference line.

130. A system comprising one or more processors and one or more memories, the one or more memories storing instructions that, when executed by the one or more processors, cause the one or more processors to:
obtain a plurality of container images;
generate, by processing the plurality of container images, a plurality of training image sets each corresponding to a different one of the plurality of container images, wherein for each training image set,
generating the training image set includes generating a different training image for each of a plurality of respective defect categories,
generating a different training image for each of the plurality of respective defect categories includes generating a first training image for a first defect category associated with a first feature, and
generating the first training image includes
identifying the first feature in the container image that corresponds to the training image set, and
generating the first training image such that the first training image (i) encompasses only a subset of the container image that corresponds to the training image set, and (ii) depicts the identified first feature; and
train, using the plurality of training image sets, a plurality of neural networks to perform automated visual inspection for the plurality of defect categories, each of the plurality of defect categories being associated with a respective feature of containers or container contents.

131. The system of claim 130, wherein training the plurality of neural networks includes training each of the plurality of neural networks to infer a presence or absence of defects in a different one of the plurality of respective defect categories.

132. The system of claim 131, wherein training each of the plurality of neural networks includes, for each of the plurality of training image sets, using a different training image to train a different one of the plurality of neural networks.

133. The system of claim 130, wherein identifying the first feature includes identifying the first feature using (i) template matching, or (ii) blob analysis.

134. The system of claim 130, wherein:
(i) the plurality of container images is a plurality of syringe images, and the first feature is a syringe plunger, a meniscus of a fluid, a syringe barrel, a syringe needle shield, or a syringe flange;
(ii) the plurality of container images is a plurality of cartridge images, and the first feature is a cartridge piston, a meniscus of a fluid, a cartridge barrel, or a cartridge flange; or
(iii) the plurality of container images is a plurality of vial images, and the first feature is a vial body, a vial crimp, a meniscus of a fluid, or a lyophilized cake.

135. A method of using an efficiently trained neural network to perform automated visual inspection for detection of defects in a plurality of defect categories, with each of the plurality of defect categories being associated with a respective feature of containers or container contents, the method comprising:
obtaining, by one or more processors, a plurality of neural networks each corresponding to a different one of the plurality of defect categories, the plurality of neural networks having been trained using a plurality of training image sets each corresponding to a different one of a plurality of container images, wherein for each training image set and corresponding container image,
the training image set includes a different training image for each of the plurality of respective defect categories, and
at least some of the different training images within the training image set consist of different portions of the corresponding container image, with the different portions depicting different features of the corresponding container image;
obtaining, by one or more processors, a plurality of additional container images; and
performing automated visual inspection on the plurality of additional container images using the plurality of neural networks.

136. The method of claim 135, wherein (i) the plurality of container images is a plurality of syringe images, and the different features include a syringe plunger, a syringe barrel, a syringe needle shield, and/or a syringe flange, (ii) the plurality of container images is a plurality of cartridge images, and the different features include a cartridge piston, a cartridge barrel, a barrel defect, and/or a cartridge flange, or (iii) the plurality of container images is a plurality of vial images, and the different features include a vial body, a vial crimp, and/or a lyophilized cake.

137. The method of claim 135, wherein the different training images include images down-sampled to different resolutions.

138. A method of training an automated visual inspection (AVI) neural network to more accurately detect defects, the method comprising:
obtaining, by one or more processors, a plurality of container images;
for each container image of the plurality of container images, generating, by one or more processors, a corresponding set of new images, wherein generating the corresponding set of new images includes, for each new image of the corresponding set of new images, moving a portion of the container image that depicts a particular feature to a different new position; and
training, by one or more processors, the AVI neural network using the sets of new images corresponding to the plurality of container images.

139. The method of claim 138, wherein:
(1) the plurality of container images is a plurality of syringe images, and the particular feature is one of (i) a syringe plunger, (ii) a syringe needle shield, or (iii) a wall of a syringe barrel;
(2) the plurality of container images is a plurality of cartridge images, and the particular feature is a cartridge piston or a wall of a cartridge barrel;
(3) the plurality of container images is a plurality of vial images, and the particular feature is a wall of a vial body or a crimp;
(4) the particular feature is a meniscus of a fluid within a container; or
(5) the particular feature is a top of a lyophilized cake within a container.

140. The method of 138, wherein moving the portion of the container image to the different new position includes shifting the portion of the container image along an axis of a substantially cylindrical portion of a container depicted in the container image.

141. The method of claim 138, wherein generating the corresponding set of new images further includes, for each new image of the corresponding set of new images, low-pass filtering the new image after moving the portion of the container image to the different new position.

142. The method of claim 138, wherein training the AVI neural network includes training the AVI neural network using (i) the sets of new images corresponding to the plurality of container images and (ii) the plurality of container images.

143. A method of performing automated visual inspection for detection of defects, the method comprising:
obtaining, by one or more processors, a neural network trained using a plurality of container images and, for each container image, a plurality of augmented container images, wherein for each of the augmented container images, a portion of the container image that depicts a particular feature was moved to a different new position;
obtaining, by one or more processors, a plurality of additional container images; and
performing automated visual inspection on the plurality of additional container images using the neural network.

144. The method of claim 143, wherein for each of the augmented container images, the portion of the container image that depicts the particular feature was moved by shifting the portion of the container image along an axis of a substantially cylindrical portion of a container depicted in the container image.

145. The method of claim 143, wherein each of the augmented container images was low-pass filtered (i) after the portion of the container image that depicts the particular feature was moved to the different new position, and (ii) before training the neural network using the augmented container image.

146. A method of training an automated visual inspection (AVI) neural network to more accurately detect defects, the method comprising:
obtaining, by one or more processors, a plurality of images depicting real containers;
training, by one or more processors and using the plurality of images depicting real containers, a deep generative model to generate synthetic container images;
generating, by one or more processors and using the deep generative model, a plurality of synthetic container images; and
training, by one or more processors and using the plurality of synthetic container images, the AVI neural network.

147. The method of claim 146, wherein training the deep generative model includes training a generative adversarial network (GAN).

148. The method of claim 147, wherein:
training the GAN includes applying, as inputs to a discriminator neural network, (i) the plurality of images depicting real containers and corresponding real image labels, and (ii) synthetic images generated by a generator neural network and corresponding fake image labels; and
generating the plurality of synthetic container images is performed by the trained generator neural network.

149. The method of claim 147, wherein:
training the GAN includes training a cycle GAN; and
generating the plurality of synthetic container images includes transforming images of real containers that are not associated with any defects to images that exhibit a defect class.

150. The method of claim 146, wherein:
generating the plurality of synthetic container images includes seeding a respective particle location for each of the plurality of synthetic container images; and
seeding the respective particle location for each of the plurality of synthetic container images includes randomly seeding the respective particle location for each of the plurality of synthetic container images.

151. A method of performing automated visual inspection for detection of defects, the method comprising:
obtaining, by one or more processors, a neural network trained using synthetic container images generated by a deep generative model;
obtaining, by one or more processors, a plurality of additional container images; and
performing automated visual inspection on the plurality of additional container images using the neural network.

152. The method of claim 151, wherein:
obtaining the neural network includes obtaining a neural network trained using a generative adversarial network (GAN); or
obtaining the neural network includes obtaining a neural network trained using a cycle GAN.
